(19) United States
(12) Patent Application Publication
(10) Pub. No.: US 2025/0199731 A1
(43) Pub. Date: Jun. 19, 2025

(54) PRINTING APPARATUS, CONTROL METHOD FOR PRINTING APPARATUS, AND INFORMATION PROCESSING APPARATUS

(71) Applicant: CANON KABUSHIKI KAISHA, Tokyo (JP)

(72) Inventor: Masao Maeda, Kanagawa (JP)

(21) Appl. No.: 18/979,740

(22) Filed: Dec. 13, 2024

(30) Foreign Application Priority Data
Dec. 18, 2023 (JP) 2023-212975

(51) Int. Cl. G06F 3/12; G06K 15/00

(52) U.S. Cl. CPC G06F 3/1236; G06F 3/1204; G06F 3/1292; G06K 15/4055

(57) ABSTRACT

In a printing apparatus capable of communicating via a wired interface and a wireless interface with a terminal device that can transmit a job for execution of an operation and capable of operating by power supplied by the terminal device connected via the wired interface, a determination unit determines whether or not the operation based on the job can be executed, based on a power supply capacity of the terminal device connected via the wired interface, and in a case where the determination unit determines that the operation based on the job cannot be executed, a connection control unit connects to the terminal device via the wireless interface for communication, and a notification control unit provides a notification that prompts improving the power supply capacity for the printing apparatus.

### BACKGROUND OF THE INVENTION

### Field of the Invention

The present invention relates to a printing apparatus, a control method for a printing apparatus, and an information processing apparatus.

### Description of the Related Art

Conventionally, a printing apparatus equipped with a wired interface for a wired connection and a wireless interface for a wireless connection to a terminal device that outputs a print job has been known. Such printing apparatuses are communicably connected to various terminal devices via wired interfaces and wireless interfaces, and some of these printing apparatuses are also configured to be capable of operating using power supplied from a terminal device connected via a wired interface.

Japanese Patent Laid-Open No. 2022-150474 discloses a printing apparatus that is equipped with a wired interface and a wireless interface and, even though a connection via the wired interface is established, maintains a connection via the wireless interface until communication is performed via the wired interface.

By the way, in a printing apparatus that is powered from a terminal device connected via a wired interface and that performs communication via the wired interface, it may be necessary, depending on the power supply capacity of the terminal device, to execute a process to improve the power supply capacity for the printing apparatus. Specifically, switching to a connection or terminal device with a higher power supply capacity is necessary. However, in the printing apparatus disclosed in Japanese Patent Laid-Open No. 2022-150474, after communication via a wired interface, if the connection via the wired interface or with the terminal device is switched, the communication with the terminal device that had been connected to the printing apparatus gets disconnected. Therefore, after the switching operation, the user must perform a connection operation to connect the printing apparatus to the terminal device, which places a burden on the user.

### SUMMARY OF THE INVENTION

The present invention has been made in view of the above-described issues, and provides a technology in which, while a connection relationship between a terminal device and a printing apparatus is maintained, the connection destination of the printing apparatus can be switched to another terminal device.

A printing apparatus, which is capable of communicating via a wired interface and a wireless interface with a terminal device that can transmit a job for execution of an operation and capable of operating by power supplied by the terminal device connected via the wired interface, includes: a determination unit configured to determine whether or not the operation based on the job can be executed, based on a power supply capacity of the terminal device connected via the wired interface; a connection control unit configured to connect to the terminal device via the wireless interface for communication in a case where the determination unit determines that the operation based on the job cannot be executed; and a notification control unit configured to provide a notification that prompts improving the power supply capacity for the printing apparatus in a case where the determination unit determines that the operation based on the job cannot be executed.

According to the present invention, while a communication relationship between a terminal device and a printing apparatus is maintained, switching to a terminal device that can operate a printing apparatus is possible.

Further features of the present invention will become apparent from the following description of exemplary embodiments with reference to the attached drawings.

### BRIEF DESCRIPTION OF THE DRAWINGS

FIG. 1 is a schematic configuration diagram of a printing system;

FIG. 2 is a block diagram illustrating the configuration of a control system of the printing apparatus;

FIG. 3 is a block diagram illustrating the configuration of a power supply control circuit;

FIG. 4 is a block diagram illustrating the configuration of a control system of an information processing apparatus;

FIG. 5 is a table illustrating the amount of power supply for each connection standard;

FIG. 6 is a table illustrating the execution capability in each operation type according to a connection standard;

FIG. 7 is a flowchart illustrating the details of processing of event processing;

FIG. 8 is a flowchart illustrating the details of processing of a job start process;

FIG. 9 is a flowchart illustrating the details of processing of a USB insertion process;

FIG. 10A and FIG. 10B are diagrams illustrating an example of a notification screen displayed during the job start process;

FIG. 11 is a sequence diagram for explaining a flow of improving a power supply capacity for the printing apparatus;

FIG. 12 is a flowchart illustrating the details of processing of job transmission processing;

FIG. 13 is a diagram illustrating an example of a notification screen displayed during the job transmission processing;

FIG. 14 is a flowchart illustrating the details of processing of event processing in another embodiment;

FIG. 15 is a sequence diagram for explaining a flow of ensuring a power supply capacity for the printing apparatus;

FIG. 16 is a flowchart illustrating the details of processing of event processing in another embodiment;

FIG. 17 is a flowchart illustrating the details of processing of a job start process;

FIG. 18 is a flowchart illustrating the details of processing of a USB insertion process;

FIG. 19A to FIG. 19C are diagrams illustrating an example of a notification screen displayed during the job start process; and

FIG. 20 is a sequence diagram for explaining a flow of improving a power supply capacity for the printing apparatus.

### DESCRIPTION OF THE EMBODIMENTS

Hereinafter, with reference to the attached drawings, an explanation is given of an example of embodiments of a printing apparatus, a control method for a printing apparatus, and an information processing apparatus. Note that the following embodiments are not intended to limit the present invention, and every combination of the characteristics explained in the present embodiments is not necessarily essential to the solution provided in the present invention. Further, the positions, shapes, etc., of the constituent elements described in the embodiments are merely examples and are not intended to limit this invention thereto.

### First Embodiment

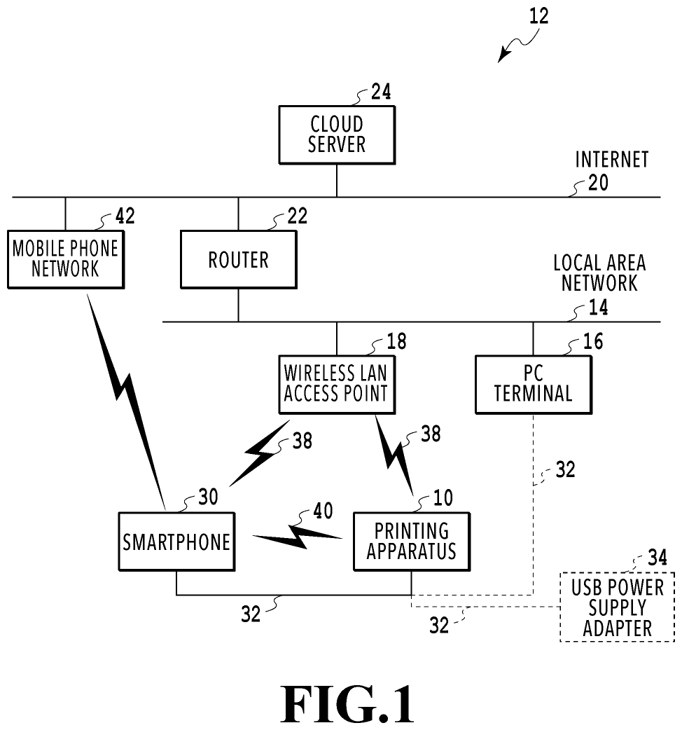

First, with reference to FIG. 1 to FIG. 11, an explanation is given about the printing apparatus according to the first embodiment.

### <Printing System>

FIG. 1 is a schematic configuration diagram illustrating a printing system including a printing apparatus according to the present embodiment. The printing system 12 including the printing apparatus 10 according to the present embodiment includes the printing apparatus 10 that performs printing by ejecting ink and the smartphone 30 that serves as a terminal device connected to the printing apparatus 10 via the local area network 14. Note that the printing system 12 includes the wireless LAN access point 18, and the printing apparatus 10 and the smartphone 30 can be connected to the local area network 14 by wirelessly connecting to the wireless LAN access point 18. Further, the printing system 12 includes the router 22 for connecting the local area network 14 to the Internet 20, and the cloud server 24 connected to the Internet 20. Accordingly, the printing apparatus 10 and the smartphone 30 can communicate with the cloud server 24 connected to the Internet 20 via the router 22.

The printing apparatus 10 includes a USB (Universal Serial Bus) connection terminal and is configured to be connectable to various devices. In the present embodiment, the printing apparatus 10 includes the USB connector 214 to which a USB cable can be connected, and is connected to the smartphone 30 via the USB cable 32. This allows the printing apparatus 10 to operate using power supplied from the smartphone 30 via the USB cable 32. Thus, in the present embodiment, the printing apparatus 10 is configured to be connectable to a terminal device such as the smartphone 30 via a wired interface implemented by the USB connector 214 and the USB cable 32 (hereinafter also referred to as the “USB interface”).

Further, in the printing system 12, a personal computer (PC terminal) 16 can also be used as a terminal device. In this case, the PC terminal 16 and the printing apparatus 10 are connected via the USB cable 32, and the printing apparatus 10 can operate using power supplied from the PC terminal 16. Furthermore, in the printing system 12, the printing apparatus 10 and the USB power supply adapter 34 are connected via the USB cable 32, and the printing apparatus 10 can operate using power supplied from a commercial power source. Note that, although illustration in the drawings is omitted, the printing apparatus 10 is also configured to be operable using power supplied via the USB cable 32 from a mobile battery or a USB host port installed on an airplane or bus seat, etc. Further, it is assumed that the terminal device in the present specification includes the USB power supply adapter 34 and the like, as well as an information processing apparatus (described later) such as the PC terminal 16 and the smartphone 30.

The wireless LAN infrastructure mode connection 38 is utilized between the smartphone 30 and the printing apparatus 10 and the wireless LAN access point 18. The printing apparatus 10 has a mode in which the printing apparatus 10 operates as a wireless LAN access point. At the time the printing apparatus 10 operates as an access point, the smartphone 30 can directly connect to the printing apparatus 10 (the direct connection 40). Further, via the mobile phone network 42, the smartphone 30 is capable of connecting to the cloud server 24 connected to the Internet 20.

In a case where the printing apparatus 10 and the PC terminal 16 and the smartphone 30 are connected by USB cables, the USB cables can be utilized for data communication between the printing apparatus 10 and the PC terminal 16 and the smartphone 30. However, there is no such limitation. It is also possible that the printing apparatus 10 operates using power supplied from the PC terminal 16 and the smartphone 30 connected via the USB cables, and data communication is executed by utilizing a wireless LAN or short-range wireless communication. Note that the printing system 12 illustrated in FIG. 1 is an example of the printing system including the printing apparatus 10 according to the present embodiment, and may have a configuration different from that illustrated in FIG. 1. For example, instead of the wireless LAN access point 18 and the router 22, a single configuration including these functions, such as a router with an access point function, may be used.

### <Configuration of the Control System of the Printing Apparatus>

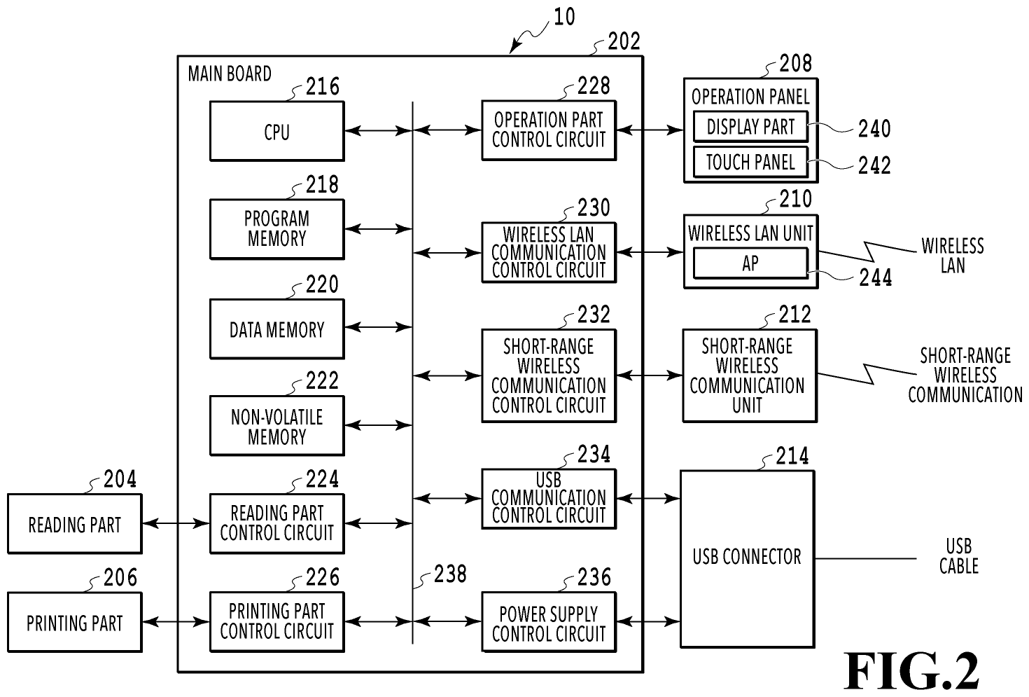

Next, an explanation is given about the configuration of the control system of the printing apparatus 10. FIG. 2 is a block diagram illustrating the configuration of the control system of the printing apparatus 10. In the present embodiment, as an example of the printing apparatus 10, an explanation is given of what is termed as a multifunction printer, which incorporates a printing mechanism and a reading mechanism inside the same housing and supports multiple functions such as a copy function.

The printing apparatus 10 includes the main board 202 that controls the entire printing apparatus 10, the reading part 204 that reads original documents, the printing part 206 that performs printing on print media, and the operation panel 208 that can be operated by users. Further, the printing apparatus 10 also includes the wireless LAN unit 210 for connecting to a wireless LAN, the short-range wireless communication unit 212 for performing short-range wireless communication, and the USB connector 214 that can be connected to the USB cable 32. In this way, the printing apparatus 10 is not only connectable to a terminal device via the USB connector 214 or the like, but is also configured to be connectable to a terminal device such as the smartphone 30 via a wireless interface implemented by the wireless LAN unit 210 and a wireless LAN or the like. Note that, hereinafter, the wireless interface implemented by the wireless LAN unit 210 and a wireless LAN or the like is also be referred to as a “wireless LAN interface.”

The main board 202 includes the CPU 216 in the form of a microprocessor, the program memory 218 in the form of a ROM, the data memory 220 in the form of a RAM, and the non-volatile memory 222 capable of retaining saved information even with no power supply. Further, the main board 202 includes the reading part control circuit 224 for controlling the reading part 204, the printing part control circuit 226 for controlling the printing part 206, and the operation part control circuit 228 for controlling the operation panel 208. Furthermore, the main board 202 includes the wireless LAN communication control circuit 230 for controlling the wireless LAN unit 210, and the short-range wireless communication control circuit 232 for controlling the short-range wireless communication unit 212. Moreover, the main board 202 includes the USB communication control circuit 234 that controls the driving of the USB connector 214, and the power supply control circuit 236 that controls the amount of power supply from the USB connector 214. The configurations installed on the main board 202 are connected to each other via the internal bus 238.

The CPU 216 operates based on the control programs stored in the program memory 218 and the information retained in the data memory 220, using the data memory 220 as a work area. Further, the CPU 216 writes various setting values, data, etc., to the non-volatile memory 222, and thereby, if the power supply is turned off and then turned on again, the CPU 216 can continue to operate based on the setting values and data written in the non-volatile memory 222. As the non-volatile memory 222, for example, a semiconductor storage device such as a flash memory can be used. Flash memories can maintain stored contents even though power application is cut off, but there is often a restriction on the number of times each memory element can be rewritten. For this reason, the timings of writing to the non-volatile memory 222 during the product lifetime of the printing apparatus 10 need to be taken into consideration in designing. Generally, the more times a storage device is guaranteed to be rewritten, the higher its unit price.

The CPU 216 controls the reading part 204 via the reading part control circuit 224 to read an original document and stores the read data in the data memory 220 as image data. Furthermore, the CPU 216 controls the printing part 206 via the printing part control circuit 226 to perform printing on a print medium based on print data obtained by performing image processing on the image data stored in the data memory 220. Further, the CPU 216 controls the operation part control circuit 228 to display the status of the printing apparatus 10 on the display part 240 and the touch panel 242 installed on the operation panel 208, to display a menu of selectable functions, and to accept operations from users.

The CPU 216 controls the wireless LAN unit 210 via the wireless LAN communication control circuit 230 to perform wireless LAN communication with other communication terminal devices. Note that the wireless LAN unit 210 includes the access point 244 for connecting to other terminal devices (the later-described information processing apparatus) and the like. In the present specification, an “access point” is appropriately referred to as an “AP.” Further, the CPU 216 controls the short-range wireless communication unit 212 via the short-range wireless communication control circuit 232 to detect connections with other short-range wireless communication terminals and to transmit and receive data to and from other short-range wireless communication terminals. Furthermore, the CPU 216 operates the USB connector 214 via the USB communication control circuit 234 to perform USB communication with other external devices connected via USB cables. Moreover, the CPU 216 controls the power supply control circuit 236 to grasp and control the amount of power supply from the USB connector 214 and the amount of power stored in the power supply control circuit 236.

### <Configuration of the Power Supply System of the Printing Apparatus>

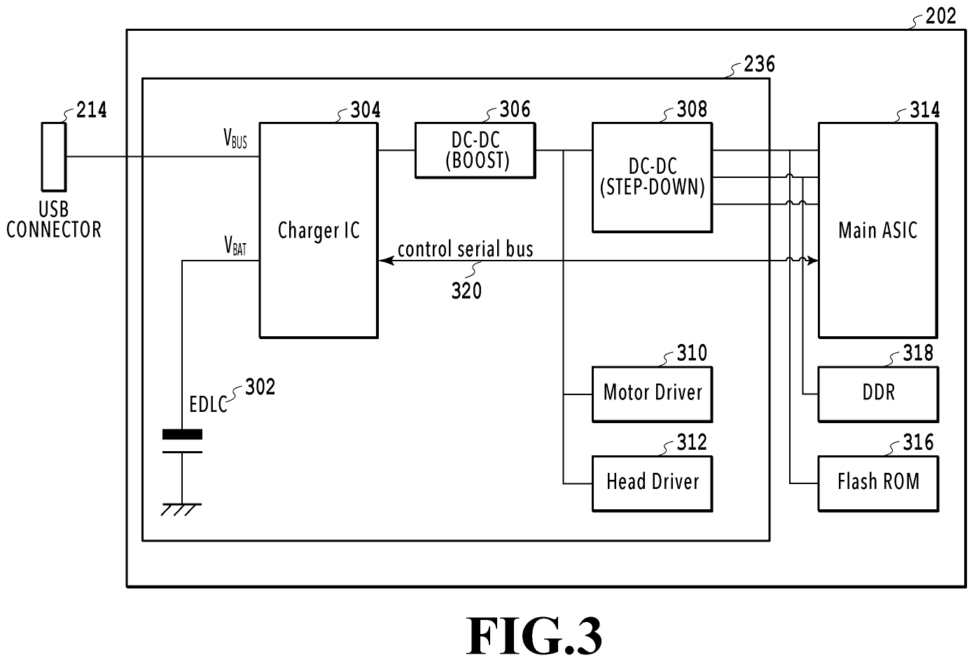

Next, an explanation is given about the configuration of the power supply system of the printing apparatus 10. FIG. 3 is a block diagram illustrating the configuration of the power supply system of the printing apparatus 10.

The power supply control circuit 236 includes the electric double layer capacitor (EDLC) 302 capable of storing and supplying power, and the Charger IC 304 that controls the current that has been input, etc. Further, the power supply control circuit 236 includes the DC-DC (boost) 306, which is a booster circuit for boosting the voltage from the Charger IC 304, and the DC-DC (step-down) 308, which is a step-down circuit for stepping down the voltage output from the DC-DC 306. Furthermore, the power supply control circuit 236 includes the Motor Driver 310, which drives the motors in the reading part 204 and the printing part 206, and the Head Driver 312, which drives a reading head (not illustrated in the drawings) and a print head (not illustrated in the drawings).

The printing apparatus 10 can be driven by the power supply voltage VBUS from the USB connector 214 and the power supply voltage VBAT from the EDLC 302, and the power supply is controlled by the Charger IC 304. The voltage output from the Charger IC 304 is boosted by the DC-DC (boost) 306, and the voltage boosted by the DC-DC 306 is used by the Motor Driver 310 to drive the motors of the reading part 204 and the printing part 206. Further, the voltage boosted by the DC-DC 306 is used by the Head Driver 312 to drive the reading head of the reading part 204 and the print head of the printing part 206. In the power supply control circuit 236, the voltage boosted by the DC-DC 306 is used for driving with a relatively large load. Furthermore, the voltage boosted by the DC-DC 306 is input to the DC-DC 308, which generates a logic power supply voltage to be used by the ASIC 314, the ROM 316, and the DDR 318. Note that the ASIC 314 is a custom IC that includes the CPU 216 and its peripheral circuits.

The Charger IC 304 is an IC with functions of controlling the current that has been input from the USB connector 214 and controlling the charging and executing protection from abnormal operations for the EDLC 302. The Charger IC 304 is capable of communicating with the ASIC 314 connected via the control serial bus 320. Note that the Control Serial Bus 320 constitutes part of the internal bus 238. In the present embodiment, communication between the Charger IC 304 and the ASIC 314 is performed using the UART (Universal Asynchronous Receiver Transmitter) system.

The Charger IC 304 makes a determination for the input current in accordance with the terminal device that supplies power (such as the PC terminal 16, the smartphone 30, or the USB power supply adapter 34). In the present embodiment, for example, a determination based on the USB-BC (USB Battery Charge) standard (BC determination) and a determination based on the USB-PD (USB Power Delivery) standard (CC determination) are made. The ASIC 314 that has received the results of the BC determination and the CC determination from the Charger IC 304 determines threshold values of the charge current, full charge, over-discharge voltage, etc., for the Charger IC 304, so that the threshold values are set for the Charger IC 304.

The EDLC 302 is an electric double layer capacitor. The EDLC 302 is subject to charging control from the Charger IC 304 in response to instructions from the ASIC 314, and supplies power to the DC-DC 306, the Motor Driver 310, and the Head Driver 312 using the power supply voltage VBAT. The power supply voltage VBAT of the EDLC 302 can be transmitted from the Charger IC 304 to the ASIC 314. In addition, various information related to power supply can be transmitted from the Charger IC 304 to the ASIC 314. Such information is used for various controls of the printing apparatus 10.

For example, if the power supply voltage VBAT of the EDLC 302 drops during a printing operation of the printing apparatus 10, the ASIC 314 stops the printing operation and instructs the Charger IC 304 to perform charging control until the power supply voltage VBAT of the EDLC 302 reaches a certain threshold value. Then, if the ASIC 314 receives a notification from the Charger IC 304 that the power supply voltage VBAT has reached the certain threshold value, the ASIC 314 resumes the printing operation. Further, for example, if the power supply is stopped because the USB cable is unplugged during the operation using power supplied from the USB connector 214, an operation to attend to the stop of power supply is immediately started based on a notification from the Charger IC 304 to the ASIC 314.

### <Information Processing Apparatus>

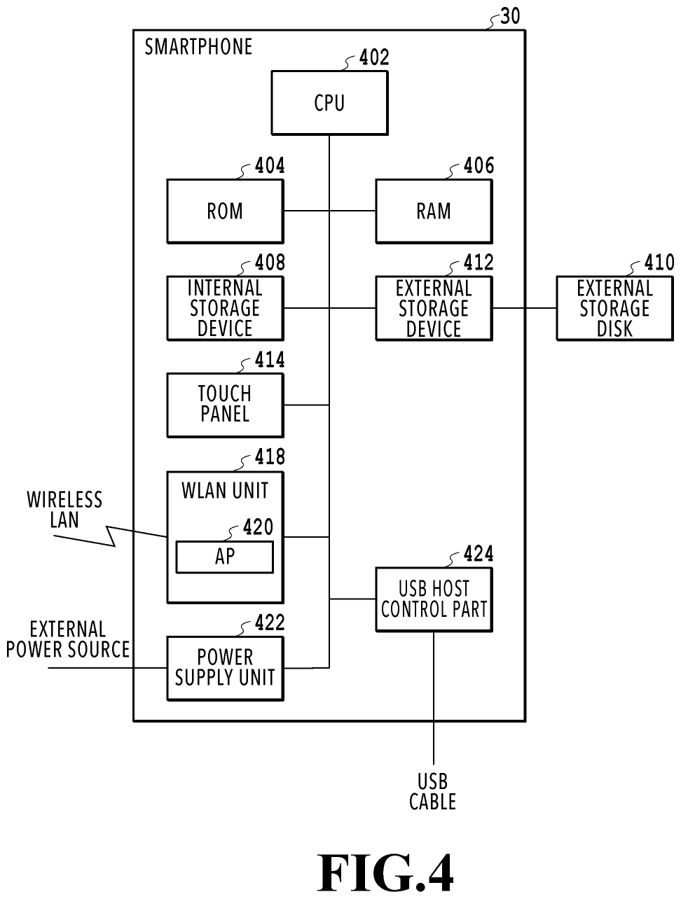

Next, in the printing system 12, an explanation is given about the configuration of an information processing apparatus, such as the PC terminal 16 and the smartphone 30, that can input and transmit jobs and various information to the printing apparatus 10. FIG. 4 is a schematic configuration diagram of an information processing apparatus. Note that, in the explanation using FIG. 4, the smartphone 30 which is connected to the printing apparatus 10 via the USB cable 32 in the printing system 12 and serves as a power supply source for the printing apparatus 10 is described as an example of the information processing apparatus.

The smartphone 30 serving as an information processing apparatus includes the CPU 402 that controls the overall operation of the smartphone 30 in accordance with each program stored in a storage area or the like, which is described later. Further, the smartphone 30 includes the ROM 404, which stores a control program or the like for the CPU 402, and the RAM 406, which temporarily stores various information and functions as a working area for the CPU 402. Furthermore, the smartphone 30 includes the internal storage device 408 that stores an operating system, various application programs such as operation apps (described later), image data, etc.

The smartphone 30 includes the external storage device 412 that acquires application software to be stored in the internal storage device 408 via the external storage disk 410, which has received the application software from another computer-readable storage medium on which the application software is stored. Note that the external storage disk may be a CD or DVD medium or the like. Further, the smartphone 30 includes the touch panel 414 that has functions as an operation part that accepts input from the user and as a display part that can display various types of information.

The smartphone 30 includes the WLAN unit 418 for connecting to a wireless LAN. Note that the specific functions of the WLAN unit 418 are the same as those of the wireless LAN unit 210. This WLAN unit 418 includes the AP 420 for connecting to the printing apparatus 10 and other information processing apparatuses. Further, the smartphone 30 includes the power supply unit 422 that supplies power necessary for operation. The power supply unit 422 is capable of receiving power from an external power source such as an AC power supply and storing the power.

The smartphone 30 has a function as a host in a USB connection, and includes the USB host control part 424 that establishes a connection with the printing apparatus 10 via the USB cable 32. If the printing apparatus 10 or another information processing apparatus is connected to the USB host control part 424 via the USB cable 32, the CPU 402 instructs the power supply unit 422 to supply power to the USB host control part 424. As a result, the USB host control part 424 supplies power to the printing apparatus 10 via the USB cable 32. The power supplied to the printing apparatus 10 via the USB cable 32 is supplied to the power supply control circuit 236 via the USB connector 214.

The USB connector 214 can simultaneously perform power supply from a terminal device to the printing apparatus 10 and perform communicate between the terminal device and the printing apparatus 10. Therefore, the printing apparatus 10 can also receive print data from the smartphone 30 via the USB connector 214. Accordingly, in the present embodiment, the smartphone 30 can cause the printing apparatus 10 to perform printing via the USB connector 214, and after connecting to a wireless LAN, can cause the printing apparatus 10 to execute printing wirelessly.

### <Connection Standards>

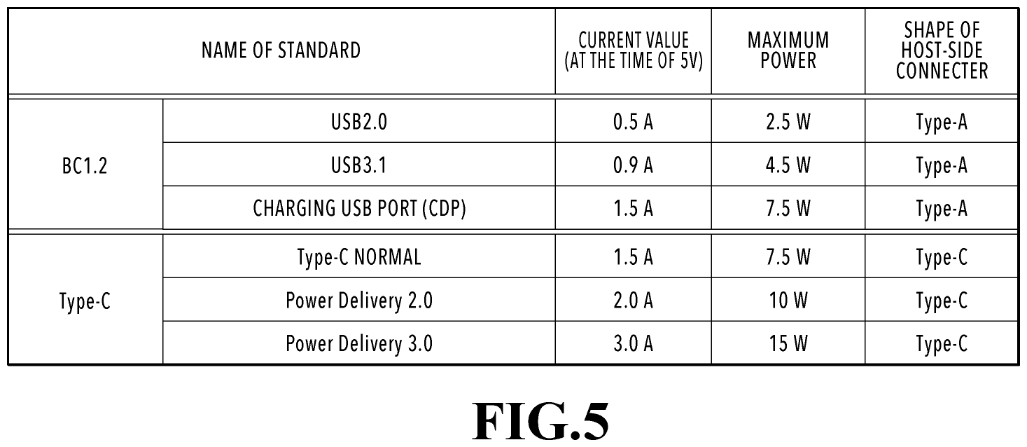

Next, an explanation is given about connection standards between the printing apparatus 10 and terminal devices including the USB power supply adapter 34, the smartphone 30, and the PC terminal 16. FIG. 5 is a table illustrating the amount of power supply for each connection standard.

BC1.2 complies with the USB-BC (Battery Charge) standard, and, as a method for making a determination of the charging USB port (CDP), a method of electrical determination using D+ and D− signal lines for data communication of the USB port is defined. Further, in a case of a standard USB port, which is not a charging port, after this detection is completed, communication based on the USB standard is carried out, during which the USB version can be determined.

Further, USB Type-C defines the Power Delivery standards, in which the amount of power supply can be notified through communication via a CC pin. Note that, in the Power Delivery standards, the power supply voltage can be controlled from 5V to 48V, but in FIG. 5, the maximum power is shown as the value of the case where 5V is supplied.

### <Execution Capabilities for the Operation Types According to Connection Standards>

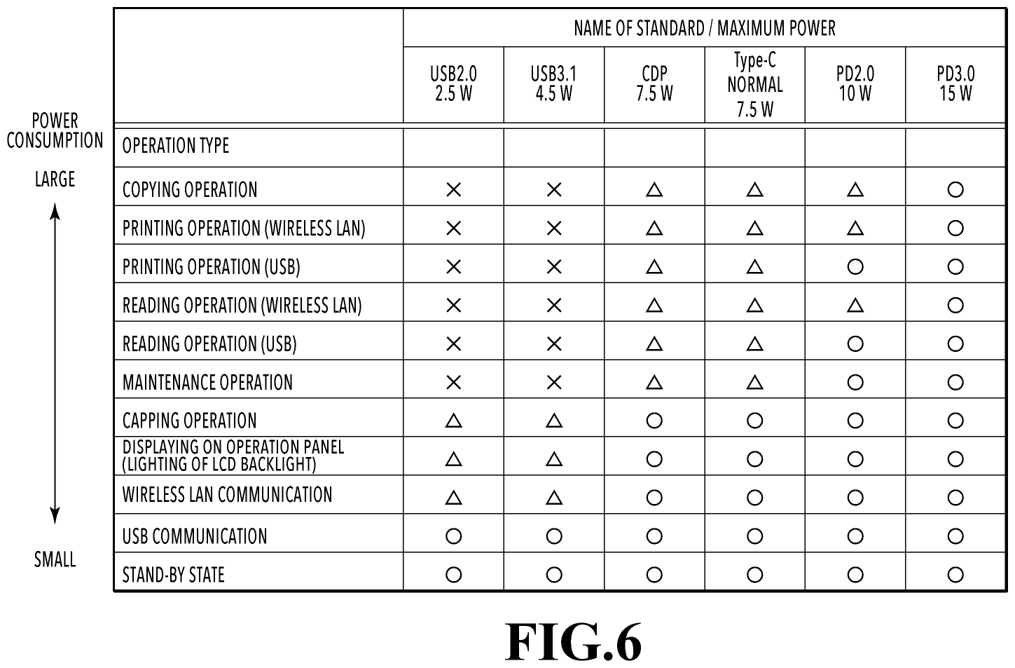

Next, an explanation is given about the execution capabilities for various operations that can be executed by the printing apparatus 10 according to the connection standards. FIG. 6 is a table illustrating the execution capabilities for various types of operations that can be executed by the printing apparatus 10 according to the connection standards. Hereinafter, the “table illustrating the execution capabilities for various types of operations that can be executed by the printing apparatus according to the connection standards” is also simply referred to as the “table illustrating the execution capabilities” as appropriate.

In FIG. 6, the execution capabilities are shown as combinations of the types of operations that can be executed by the printing apparatus 10 (the operation types) and the types of power supply standards (the connection standards in FIG. 4). In the printing apparatus 10, such a table showing execution capabilities as that of FIG. 6 may be stored as table data in the program memory 218, or may be implemented as a determination code in the form of a program code.

The operation types include a copy operation for printing a read original document, a printing operation for performing printing based on print data, a reading operation for reading an original document, and a maintenance operation for the printing part 206. The maintenance operation is an operation for maintaining and recovering good printing characteristics in the printing part 206. In the present embodiment, the printing part 206 performs printing on a print medium by an inkjet system. Therefore, in the maintenance operation, ink is forcibly suctioned from the nozzles of the print head, ink ejection that does not contribute to printing is executed into a cap that caps the nozzle surface, and the nozzle surface is wiped.

Further, the operation types include a capping operation for protecting the print head with a cap. By capping the nozzle surface of the print head for protection, it is possible to prevent ink from drying out or solidifying inside the nozzles, and also to prevent the head from being damaged by moving due to vibrations at the time the printing apparatus 10 is transported. During the capping operation, power is consumed for the driving of the motors to move the print head to a position where the capping can be performed and to press the cap against the head, but with the capping operation only, power consumption can be suppressed compared with the maintenance operation.

Furthermore, the operation types include displaying on the operation panel 208, wireless LAN communication, and USB communication. Displaying on the operation panel 208, wireless LAN communication, and USB communication are executed in parallel with other operations, but consume power even in a state where no other operations are being performed. For example, for displaying on the operation panel 208, power is consumed to display a screen on the display part 240. Further, in wireless LAN communication, power is consumed to operate the wireless LAN unit 210. In FIG. 6, the operation types listed higher generally consume more power.

In FIG. 6, the execution capabilities for the respective operation types are expressed in three levels: “o”, “Δ”, and “X” In the combinations of operation type and power supply standard type, “o” indicates that the power required for the operation is below the power supply capacity, and thus the operation can be performed continuously. “Δ” indicates that the power required for the operation exceeds the power supply capacity, but the operation can be performed by consuming the power stored in the EDLC 302. Note that this operation cannot be performed continuously, but can be performed under a condition, such as reducing the power consumption per unit time by slowing down the speed or the like, executing the operation intermittently with an appropriate pause period for charging, etc. “x” indicates that the power required for the operation significantly exceeds the power supply capacity, and even with use of the power of the EDLC 302, the operation cannot be performed even under conditions.

### <Event Processing>

In the printing apparatus 10 configured as described above, if the operation of turning on the power supply is performed by providing the logic power supply to the ASIC 314, event processing for executing a process according to the event type is started. Note that an event is any of a variety of operations or processes that can be executed by the printing apparatus 10. In the present embodiment, it is assumed that the printing apparatus 10 and the smartphone 30 are connected via the USB cable 32, and that the printing apparatus 10 is powered by the smartphone 30 and is capable of communicating with the smartphone 30 via the USB cable 32.

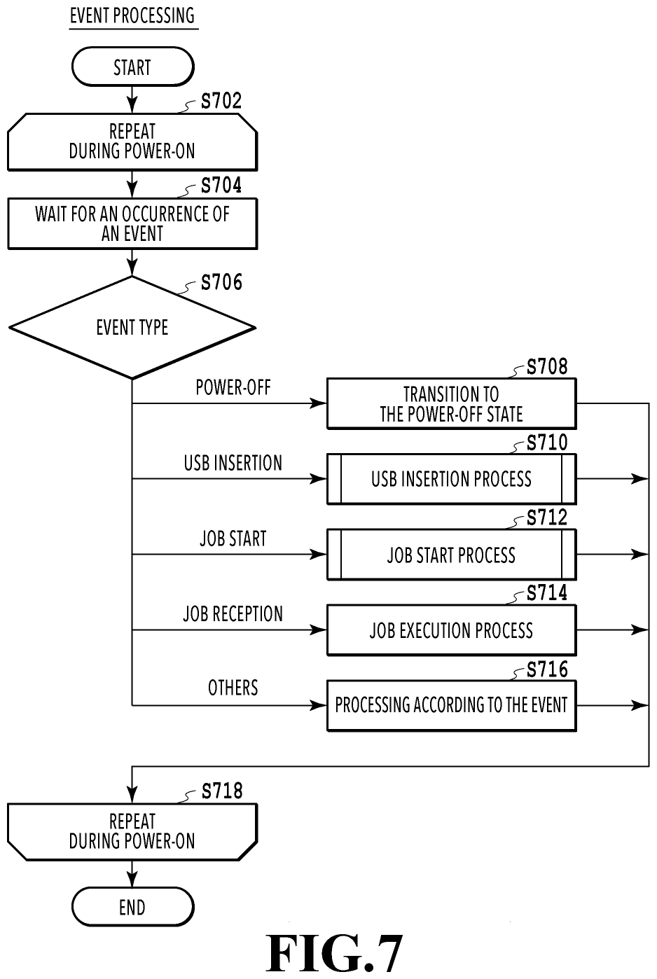

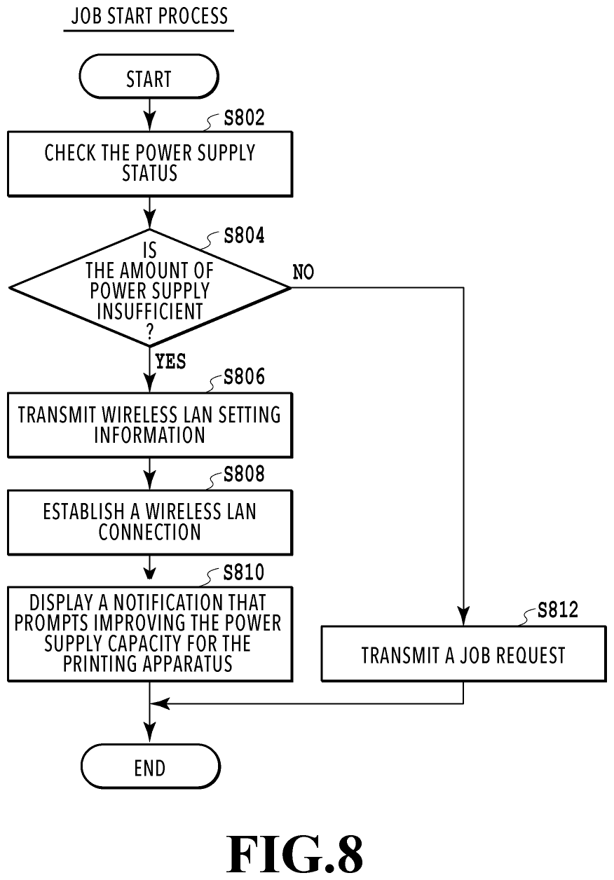

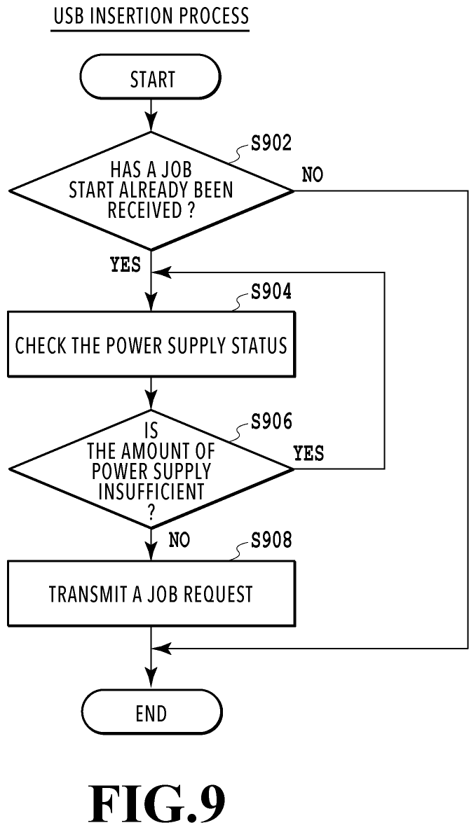

FIG. 7 is a flowchart illustrating the details of processing of event processing. FIG. 8 is a flowchart illustrating the details of processing of a job start process, which is a subroutine of the event processing. FIG. 9 is a flowchart illustrating the details of processing of a USB insertion process, which is a subroutine of the event processing.

The series of processes illustrated in the flowcharts of FIG. 7 to FIG. 9 is performed by the CPU 216 loading a program code stored in the program memory 218 into the data memory 220 and executing it. Alternatively, part or all of the functions in the steps of FIG. 7 to FIG. 9 may be executed by hardware such as an ASIC or an electronic circuit. In the present specification, the sign “S” in the explanation of each process in a flowchart indicates that it is a step in that flowchart.

If the event processing is started, the processes from S702 to S718 are repeatedly executed in a loop until the printing apparatus 10 is turned off or the logic power supply to the ASIC 314 is cut off. During the loop, in S704, the CPU 216 waits for the occurrence of an event to be processed. Next, in S706, the CPU 216 determines the type of the event that has occurred. Each process subsequent to S706 is what is termed as an event-driven process, in which processing according to the type of the event that has occurred is performed.

Hereinafter, an explanation is given about the processes subsequent to S706. If the event is detection of a power-off operation, the processing proceeds to S708 to transition to the power-off state. That is, the printing apparatus 10 is brought into the power-off state. As a result, the CPU 216 exits the repeated loop in S718 and ends the event processing.

If the event is detection of the insertion of a USB cable, the processing proceeds to S710, where the CPU 216 executes a USB insertion process. The USB insertion process is described in detail later. If the event is the reception of a notification of a job start from the smartphone 30 via the USB connector 214, the processing proceeds to S712, where the CPU 216 executes the job start process. At this time, for example, a flag for determining whether a notification of a job start (hereinafter also referred to as “information related to the start of a job”) has been received is turned ON. The job start process is described in detail later. Note that an operation that can be executed by the printing apparatus 10 is set in a job, and the job includes, for example, a print job for performing a printing operation, a scan job for performing an original document reading operation, a copy job for performing a copying operation, etc.

If the event is the reception of a job from the smartphone 30 via the USB connector 214 or the wireless LAN unit 210, the processing proceeds to S714, where the job execution process is performed. Regarding the operation to be performed at the execution of a job, the operation contents are determined by the contents notified by the job, and, in the job execution process, various operations set in the job, such as printing, scanning, copying, or the like, are to be executed. If the event is something else, the processing proceeds to S716, where the CPU 216 performs processing according to the event that has occurred.

### =Job Start Process=

Next, an explanation is given about the job start process executed in S712 with reference to FIG. 8. In the job start process, first, in S802, the CPU 216 checks the power supply status. In S802, the results of the BC determination and CC determination detected by the power supply control circuit 236 at the time of the insertion of the USB cable 32 are referenced, thereby acquiring the connection standard and the current value.

Next, in S804, the CPU 216 determines whether or not the amount of power supply from the smartphone 30 is insufficient for the job to be executed. That is, in S804, whether or not the power supply capacity from the smartphone 30 via the USB cable 32 is adequate for the job (operation) to be executed is determined. Specifically, in S804, the determination is made based on the table showing the execution capabilities (see FIG. 6), referring to the operation to be executed in the job, the connection standard, and the current value. For example, if the symbol representing the execution capability is “O”, it is determined that the amount of power supplied from the smartphone 30 is not insufficient, i.e., that the power supply capability from the smartphone 30 via the USB cable 32 is adequate for the job to be executed. Further, if the symbol representing the execution capability is “A” or “x”, it is determined that the amount of power supplied from the smartphone 30 is insufficient, i.e., that the power supply capacity from the smartphone 30 via the USB cable 32 is not adequate for the job to be executed. In S804, the determination may be made according to the contents of the job to be executed. For example, in a case where the job is a print job, the determination threshold value for the amount of power supply can be changed depending on whether the printing contents are color or monochrome. Further, the determination threshold value may be changed according to the number of sheets to be printed in the print job. If it is determined in S804 that the amount of power supplied from the smartphone 30 is insufficient, it is determined that the job to be executed cannot be executed. Further, if it is determined in S804 that the amount of power supplied from the smartphone 30 is not insufficient, it is determined that the job to be executed can be executed. In this way, in the present embodiment, the CPU 216 functions as a determination part that determines, based on the amount of power supplied from the smartphone 30, whether or not an operation based on a job to be executed can be executed.

If it is determined in S804 that the amount of supplied power is insufficient, the processing proceeds to S806, where the CPU 216 transmits, to the smartphone 30, wireless LAN setting information for establishing a wireless LAN connection with the printing apparatus 10. Thereafter, in S808, the CPU 216 enables the wireless LAN unit 210 of the printing apparatus 10 so as to be connectable with the wireless LAN setting information transmitted in S806, and waits for a wireless LAN connection with the smartphone 30 to be established. In this way, in the present embodiment, the CPU 216 functions as a connection control part for establishing a wireless LAN connection with the smartphone 30.

Note that, in the herein-provided explanation, the printing apparatus 10 transmits wireless LAN setting information to the smartphone 30, and the smartphone 30 performs a connection process in accordance with the wireless LAN setting information. However, there is no such limitation. It is also possible that the printing apparatus 10 requests the smartphone 30 for wireless LAN setting information, and uses the wireless LAN setting information received from the smartphone 30 in response, so as to establish a wireless LAN connection from the printing apparatus 10 side. Note that various connection forms can also be used for the wireless LAN connection between the printing apparatus 10 and the smartphone 30. For example, the wireless LAN infrastructure mode connection 38 for establishing a connection via the wireless LAN access point 18 can be used. Alternatively, it is also possible to use a Wi-Fi (registered trademark) direct connection (the direct connection 40) in which the printing apparatus 10 operates as an access point and the smartphone 30 joins it. The connection forms and the connection parameters to be used are to be designated by the wireless LAN setting information.

Once the wireless LAN connection is established, communication between the printing apparatus 10 and the smartphone 30 can be performed using the wireless LAN. As a result, even if the USB cable 32 is removed from the printing apparatus 10, the state where the printing apparatus 10 and the smartphone 30 can communicate with each other is maintained. Therefore, if the wireless LAN connection is established in S808, the processing proceeds to S810, where the CPU 216 provides a notification that prompts improving the power supply capacity for the printing apparatus 10. Note that, “improving of the power supply capacity for the printing apparatus 10” can be rephrased to “improving of the power supply capacity in the mechanism that supplies power to the printing apparatus 10”. The notification that prompts improving the power supply capacity for the printing apparatus 10 includes, for example, a notification that prompts a change to a USB cable with the symbol representing the execution capability of “o” and a notification that prompts a change to the USB cable and a change to a terminal device connected via the USB cable. In this way, in the present embodiment, the CPU 216 functions as a notification control part that provides a notification that prompts improving the power supply capacity for the printing apparatus 10.

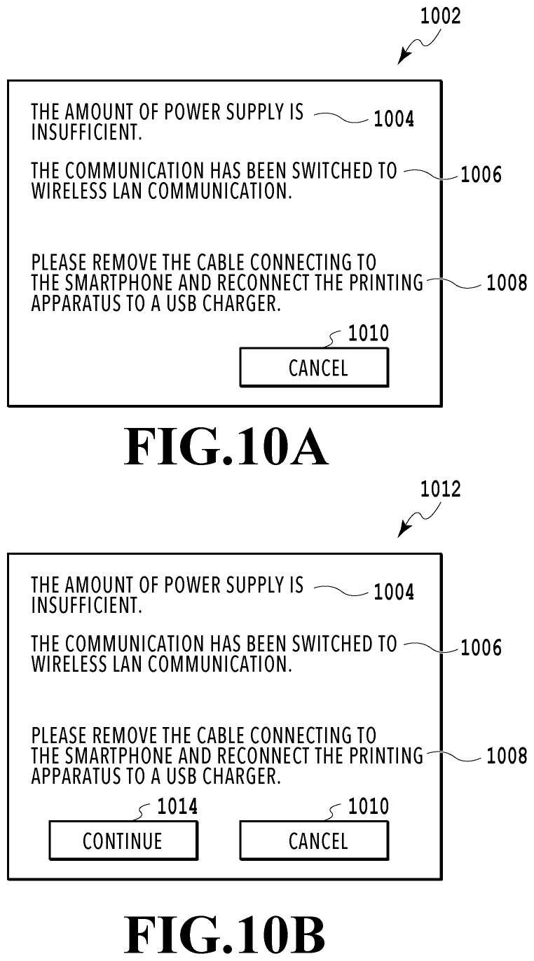

In S810, for example, the notification screen 1002 to display a notification that prompts improving the power supply capacity for the printing apparatus 10 is displayed on the display part 240 or touch panel 242 of the operation panel 208 (see FIG. 10A). Here, an explanation is given about the notification screen to display a notification that prompts improving the power supply capacity for the printing apparatus 10 on the display part 240 or the like. FIG. 10A and FIG. 10B are diagrams illustrating a notification screen to display a notification that prompts improving the power supply capacity for the printing apparatus 10, where FIG. 10A is an example of the notification screen to display the notification, and FIG. 10B is a modification example of the notification screen. The notification screen 1002 displays the error message 1004 to inform that the amount of power supplied to the printing apparatus 10 is insufficient. Further, the notification screen 1002 displays the status message 1006 to inform that the communication between the printing apparatus 10 and the smartphone 30 has been switched from USB communication via a USB cable to wireless LAN communication. Furthermore, the notification screen 1002 displays the instruction message 1008, which is a notification that prompts removing the USB cable 32 connecting the printing apparatus 10 and the smartphone 30 to improve the power supply capacity for the printing apparatus 10. In the present embodiment, a notification that prompts a connection to the USB power supply adapter 34 using a Power Delivery 3.0 USB cable (the connection standard and current value that can execute all operations of the printing apparatus 10) is displayed as the notification that prompts improving the power supply capacity for the printing apparatus 10. Moreover, the cancel button 1010 is displayed on the notification screen 1002, and if the cancel button 1010 is selected, the execution of the job that has been instructed to start is canceled.

Note that the screen displayed on the display part 240 or the like in S810 is not limited to the notification screen 1002, and the continue button 1014 may be displayed as in the notification screen 1012 (see FIG. 10B). For example, if the symbol representing the execution capability is “A”, it may be possible to execute the job by performing a conditional operation such as slowing down the speed or operating intermittently. In such a case, if the continue button 1014 is selected, the job is executed under a conditional operation without improving the power supply capacity for the printing apparatus 10. Note that, in this case, with a configuration that disables a wireless LAN connection and receives a job via USB communication, it is possible to reduce the power consumption required for the wireless LAN connection and use the amount of that power for job execution. Further, it is also possible that the notification screen 1012 is displayed in a case where the symbol representing the execution capability is “A”, and the notification screen 1002 is displayed in a case where the symbol is “x”.

Returning to FIG. 8, the explanation is continued. On the other hand, if it is determined in S804 that the amount of power supply is not insufficient, it is possible to receive a job via USB communication and execute operations based on the job, and thus there is no need to switch to wireless LAN communication or improve the power supply capacity for the printing apparatus 10. Therefore, if it is determined in S804 that the amount of supplied power is not insufficient, the processing proceeds to S812, where the CPU 216 transmits a job request to the smartphone 30 via USB communication, and then this job start process ends. Note that, at the time of ending the job start process, the flag that was set to ON upon reception of the notification of a job start is initialized to OFF.

### =USB Insertion Process=

Next, an explanation is given about the USB insertion process executed in S710 with reference to FIG. 9. In the USB insertion process, first, in S902, the CPU 216 determines whether or not a notification of a job start has already been received. In S902, whether or not a flag for determining whether a notification of a job start has been received is ON is determined. If the flag is ON, it is determined that a notification of a job start has already been received, and if the flag is OFF, it is determined that a notification of a job start has been unreceived.

If it is determined in S902 that a notification of a job start has been unreceived, i.e., has not been received yet, this USB insertion process ends. That is, if it is determined in S902 that a notification of a job start has not been received yet, it is conceivable that the printing apparatus 10 and the smartphone 30 are connected via the USB cable 32, and it is sufficient that a connection via the USB cable 32 has been established in hardware.

If it is determined in S902 that a notification of a job start has already been received, this USB insertion event is an event that occurs after the user executed a process for improving the power supply capacity for the printing apparatus 10 based on the notification screen displayed in the job start process of S810. Therefore, if it is determined in S902 that a notification of a job start has already been received, the processing proceeds to S904, where the CPU 216 checks the power supply status. Since the specific details of processing of S904 are the same as those of S802, the explanations thereof are omitted. That is, in S904, the power supply status in a state where the user has performed a process for improving the power supply capacity for the printing apparatus 10 is to be checked. The process for improving the power supply capacity for the printing apparatus 10 includes changing to a USB cable with a power supply capacity (connection standard, current amount) capable of executing the operations based on the job, or changing to the USB cable and changing to a terminal device connected via the USB cable, etc.

Next, in S906, the CPU 216 determines whether or not the amount of power supply is insufficient for the job to be executed. Since the specific details of processing of S906 are the same as those of S804, the explanations thereof are omitted. If it is determined in S906 that the amount of power supply is insufficient, it is determined that an improvement of the power supply capacity for the printing apparatus 10 has not been appropriately executed, and the processing returns to S904. Further, if it is determined in S906 that the amount of power supply is not insufficient, it is determined that the job execution has become possible, and the processing proceeds to S908, where the CPU 216 transmits a job request to the smartphone 30 via wireless LAN communication, and then this USB insertion process ends. Note that, after a job request is transmitted, the flag for determining whether a notification of a job start has been received is initialized to OFF.

### <Flow of Improving the Power Supply Capacity for the Printing Apparatus>

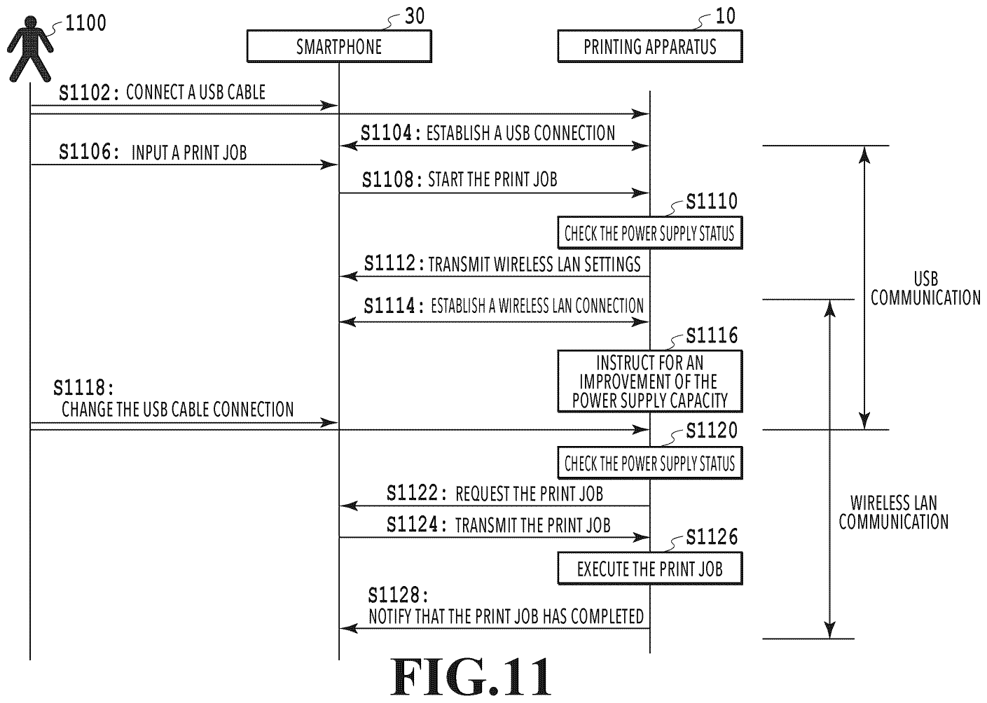

Next, an explanation is given about a flow of improving the power supply capacity for the printing apparatus 10. FIG. 11 is a sequence diagram illustrating the flow in which power supply for the printing apparatus 10 is switched from the smartphone 30 via the USB cable 32 to the USB power supply adapter 34 via a USB cable exhibiting a higher power supply capacity. Note that, in the explanation using FIG. 11, for ease of understanding, a case of executing a print job is explained.

First, in S1102, the user 1100 connects the printing apparatus 10 and the smartphone 30 with the USB cable 32. As a result, in S1104, a connection is established between the printing apparatus 10 and the smartphone 30 via the USB cable 32, enabling USB communication. Next, in S1106, the user 1100 operates the smartphone 30 to input a print job and instruct its execution. In response to this, in S1108, the smartphone 30 transmits a notification of starting a print job to the printing apparatus 10.

Upon receiving the notification of starting a print job, the printing apparatus 10 checks the power supply status in S1110 (corresponding to S802 and S804). Here, it is assumed that the result of checking the power supply status indicates that the amount of power supply is insufficient and that the power supply capacity for the printing apparatus 10 needs to be improved. Therefore, in checking the power supply status, it is determined that the amount of power supply is insufficient. If the printing apparatus 10 determines that the amount of power supply is insufficient, then in S1112, the printing apparatus 10 transmits wireless LAN setting information to the smartphone 30 (corresponding to S806). Note that, in this case, it is sufficient that the wireless LAN setting information can be exchanged and shared between the printing apparatus 10 and the smartphone 30. Therefore, it is also possible to adopt a configuration in which the printing apparatus 10 requests the smartphone 30 for wireless LAN setting information, and the smartphone 30 transmits the wireless LAN setting information to the printing apparatus 10. That is, in the present embodiment, the wireless LAN setting information is transmitted and received through USB communication. In response to this, in S1114, a wireless LAN connection is established between the smartphone 30 and the printing apparatus 10 based on the wireless LAN setting information (corresponding to S808).

Once the wireless LAN connection is established in this manner, then in S1116, the printing apparatus 10 displays the notification screen 1002 on the display part 240 of the operation panel 208 (corresponding to S810). The user 1100 checks the notification screen 1002, and in S1118, executes a process for improving the power supply capacity for the printing apparatus 10. Specifically, the USB cable 32 connecting the printing apparatus 10 and the smartphone 30 is removed from the printing apparatus 10, and the printing apparatus 10 is connected to the USB power supply adapter 34 via, for example, a Power Delivery 3.0 USB cable.

In this way, the printing apparatus 10 is capable of USB communication from the time the printing apparatus 10 and the smartphone 30 are connected via the USB cable 32 in S1102 until the time the USB cable 32 is removed from the printing apparatus 10 in S1118. Further, the printing apparatus 10 is capable of communication in both USB communication and wireless LAN communication modes from the time the wireless LAN connection is established in S1114 until the time the USB cable 32 is removed from the printing apparatus 10 in S1118. Furthermore, after the USB cable 32 is removed from the printing apparatus 10 in S1118, the printing apparatus 10 is in a state where only wireless LAN communication is possible.

If a connection is established between the printing apparatus 10 and the USB power supply adapter 34, a USB insertion event occurs, and in S1120, the printing apparatus 10 checks the power supply status (corresponding to S902 and S904). Here, a description is given of a case where, as a result of executing a process for improving the power supply capacity for the printing apparatus 10, the amount of power supply capable of executing the job is ensured. If it is determined, as a result of checking the power supply status, that the amount of power supply is not insufficient (corresponding to S906), then in S1122, the printing apparatus 10 transmits a print job request to the smartphone 30 (corresponding to S908). In response to this, in S1124, the smartphone 30 transmits a print job to the printing apparatus 10. Then, in S1126, the printing apparatus 10 performs printing based on the print job, and thereafter, in S1128, the printing apparatus 10 transmits to the smartphone 30 a notification that the printing based on the print job has completed.

### <Functional Effect>

As explained above, if the printing apparatus 10 determines that a job cannot be executed based on the power supply capacity from the smartphone 30 connected via a USB, the communication mode between the printing apparatus 10 and the smartphone 30 is changed from USB communication to wireless LAN communication. Furthermore, at this time, a notification that prompts improving the power supply capacity for the printing apparatus 10 is provided. As a result, even if the user removes the USB cable 32 from the printing apparatus 10 in order to improve the power supply capacity for the printing apparatus 10 based on the notification, the communication between the printing apparatus 10 and the smartphone 30 is maintained. Therefore, the user does not need to perform the operation of connecting the printing apparatus 10 and the smartphone 30 after performing the operation of improving the power supply capacity for the printing apparatus 10, which improves convenience.

### Second Embodiment

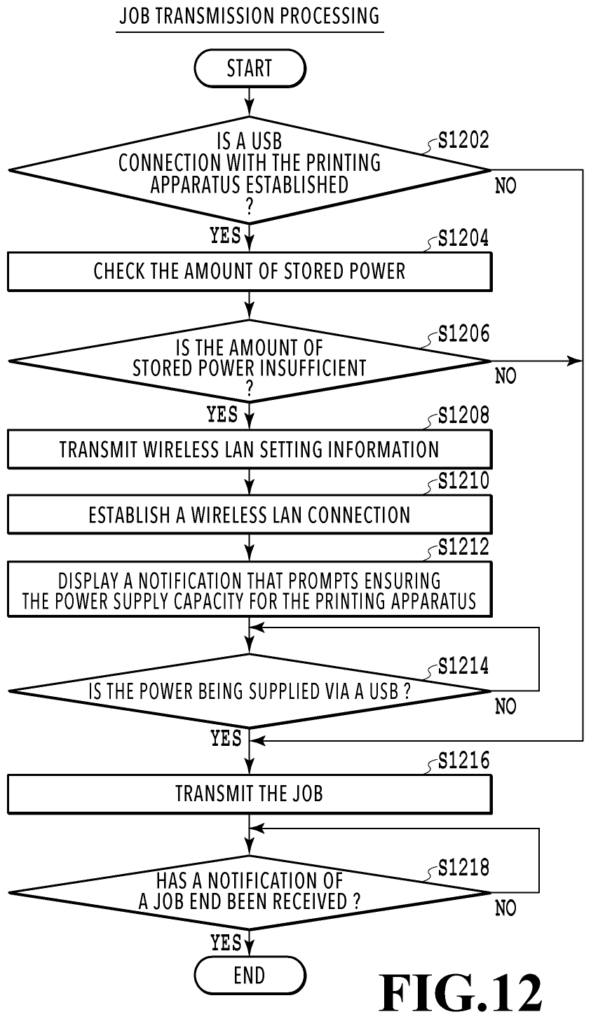

Next, with reference to FIG. 12 to FIG. 15, an explanation is given about a printing apparatus according to the second embodiment. In the following explanation, configurations that are the same or correspond to those of the printing apparatus according to the above-described first embodiment are assigned with the same signs as those used in the first embodiment, thereby omitting detailed explanations thereof.

In the first embodiment, a determination is made as to whether or not the job to be executed can be executed based on the connection standard and the amount of power, i.e., the power supply capacity from a smartphone, and then issuance of a notification for prompting an improvement of the power supply capacity and switching of communication modes are performed based on the result of this determination. Note that, depending on the amount of power stored in the smartphone, the smartphone may become unable to execute job management such as transmitting a job or receiving a notification that a job has been completed. Therefore, in the second embodiment, whether or not the job to be executed can be executed is determined based on the amount of power stored in the smartphone, and based on the result of this determination, the providing of a notification that prompts ensuring the power supply capacity for the printing apparatus 10 and the switching of communication modes are performed.

In a case where the smartphone 30 is connected to the printing apparatus 10 via the USB cable 32, the smartphone 30 is in a state supplying power to the printing apparatus 10 and not receiving power from external sources. Therefore, in this state, the smartphone 30 operates while supplying power to the printing apparatus 10 using the power stored in the smartphone 30. For this reason, if this state continues, the power stored in the smartphone 30 continues to be consumed during job execution, making it impossible for the smartphone 30 to operate, making it impossible to manage the job, and potentially making it impossible to execute or end the job on the printing apparatus 10. Thus, in the present embodiment, in order to enable the job to be executed appropriately, the power supply capacity for the printing apparatus 10 is ensured according to the amount of power stored in the smartphone 30.

### <Job Transmission Processing>

In the present embodiment, if an application (an operation app) running on the smartphone 30 to operate the printing apparatus 10 issues an instruction to execute an input job, the smartphone 30 starts the job transmission processing to transmit the job to the printing apparatus 10. FIG. 12 is a flowchart illustrating the details of processing of job transmission processing. The series of processes illustrated in the flowchart of FIG. 12 is performed by the CPU 402 loading a program code stored in the ROM 404 into the RAM 406 and executing it. Alternatively, part or all of the functions in the steps of FIG. 12 may be executed by hardware such as an ASIC or an electronic circuit.

If the job transmission processing is started, first, in S1202, the CPU 402 determines whether or not a connection with the printing apparatus 10 via the USB cable 32 (a USB connection) is established. If it is determined in S1202 that a connection with the printing apparatus 10 via the USB cable 32 is not established, the processing proceeds to S1216, which is described later. Further, if it is determined in S1202 that a connection with the printing apparatus 10 via the USB cable 32 is established, the processing proceeds to S1204, where the CPU 402 checks the amount of power stored in the power supply unit 422. In this way, in the present embodiment, the CPU 402 functions as a detection part capable of detecting the amount of power stored in the power supply unit 422, which corresponds to a power storage part of the smartphone 30.

Next, in S1206, the CPU 402 determines whether or not there is a possibility that the amount of power stored in the power supply unit 422 will become insufficient by the time the operation based on the job to be executed is completed. A threshold value is set for the storage area of the internal storage device 408, etc., and in S1206, the determination is made based on this threshold value. Specifically, in S1206, for example, the determination is made based on whether or not the amount of stored power acquired in S1204 is below the preset threshold value. Note that, the threshold value may be varied depending on the contents of the job for making the determination. For example, the threshold value may be changed depending on the type of operation, and in a case of a printing operation, the threshold value may be changed depending on whether the printing is color or monochrome, or the threshold value may be changed depending on the number of sheets to be printed. For example, such a threshold value is obtained in an experiment and set for each operation that can be executed by a job.

If it is determined in S1206 that there is no possibility that the amount of power stored in the power supply unit 422 will become insufficient, i.e., that the amount of stored power is not below the threshold value, the processing proceeds to S1216, which is described later. Further, if it is determined in S1206 that there is a possibility that the amount of power stored in the power supply unit 422 will become insufficient, i.e., that the amount of stored power is below the threshold value, the processing proceeds to S1208. In S1208, the CPU 402 transmits, to the printing apparatus 10, wireless LAN setting information for establishing a wireless LAN connection with the smartphone 30. At this time, the wireless LAN setting information is output to the printing apparatus 10 via the USB host control part 424 and the USB cable 32. Then, in S1210, the CPU 402 waits for a wireless LAN connection to be established with the printing apparatus 10 in a state connectable using the wireless LAN setting information transmitted in S1208. In this way, in the present embodiment, the CPU 402 functions as a connection control part for establishing a wireless LAN connection with the printing apparatus 10.

Note that, in the herein-explained form, the smartphone 30 transmits wireless LAN setting information to the printing apparatus 10, and the printing apparatus 10 performs connection processing accordingly. However, there is no such limitation. It is also possible that the smartphone 30 requests the printing apparatus 10 for wireless LAN setting information, and uses the wireless LAN setting information received from the printing apparatus 10 in response, so as to establish a wireless LAN connection from the smartphone 30 side. Note that various connection forms can also be used for the wireless LAN connection between the printing apparatus 10 and the smartphone 30. For example, the wireless LAN infrastructure mode connection 38 for establishing a connection via the wireless LAN access point 18 can be used. Alternatively, it is also possible to use a Wi-Fi (registered trademark) direct connection (the direct connection 40) in which the printing apparatus 10 operates as an access point and the smartphone 30 joins it. The connection forms and the connection parameters to be used are to be designated by the wireless LAN setting information.

If a wireless LAN connection can be established with the printing apparatus 10, communication between the printing apparatus 10 and the smartphone 30 can be performed using the wireless LAN. This makes it possible to execute the process for ensuring the power supply capacity for the printing apparatus 10 while maintaining communication with the printing apparatus 10. The process for ensuring the power supply capacity for the printing apparatus 10 is, for example, a process for switching the connection destination of the USB cable 32 that has been removed from the smartphone 30 to a terminal device with an enough power supply capacity. The terminal device with an enough power supply capacity is a terminal device that stores the power supply capacity to complete the operation based on the job to be executed. Note that, if that terminal device is in a form of supplying stored power (for example, a mobile battery), a terminal device with the amount of stored power capable of executing the operation based on the job is assumed. Therefore, if a wireless LAN connection is established with the printing apparatus 10, next in S1212, the CPU 402 provides on the touch panel 414 a notification that prompts ensuring the power supply capacity for the printing apparatus 10 and prompts charging the smartphone 30. Specifically, a notification that prompts connecting the USB cable 32 inserted to the printing apparatus 10 to a terminal device with an enough power supply capacity and prompts charging the smartphone 30 is provided. Thus, in the present embodiment, the CPU 402 functions as a notification control part that controls the execution of a notification that prompts changing the connection destination of the USB cable 32, i.e., connecting the USB cable 32 to a terminal device with an enough power supply capacity, and prompts charging the smartphone 30.

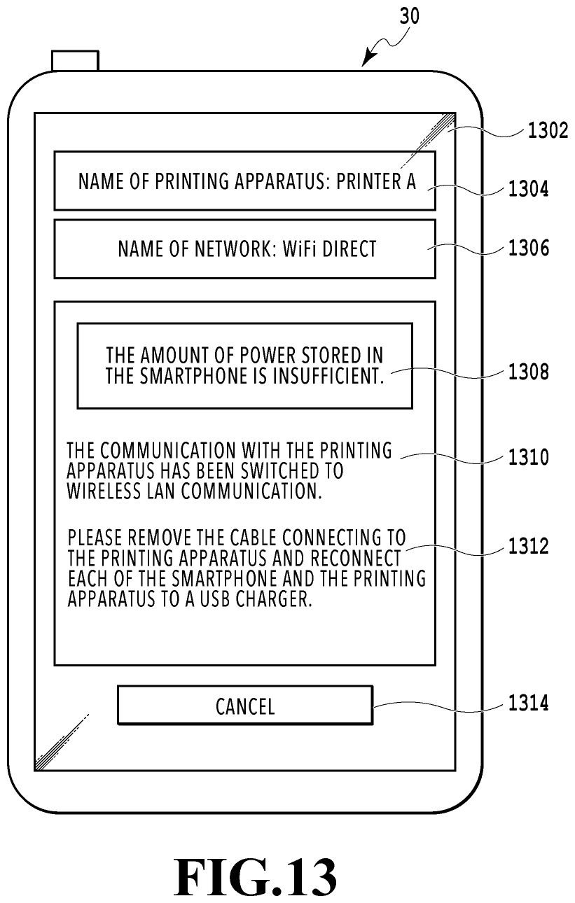

In S1212, the touch panel 414 is made to display the notification screen 1302 that displays a notification that prompts ensuring the power supply capacity for the printing apparatus 10 and prompts charging the smartphone 30. Here, an explanation is given about the notification screen on the touch panel 414 for displaying a notification that prompts connecting the USB cable 32 to a terminal device with an enough power supply capacity. FIG. 13 is a diagram illustrating an example of the notification screen displaying a notification that prompts ensuring the power supply capacity for the printing apparatus 10 and prompts charging the smartphone 30. On the notification screen 1302, the name display part 1304 displays the name of the printing apparatus 10 connected to the smartphone 30 via a wireless LAN. Further, on the notification screen 1302, the network display part 1306 displays the type of the wireless LAN to which the smartphone 30 is connected or the SSID (Service Set ID) which serves as an identifier.

The notification screen 1302 displays the error message 1308 to inform that the amount of power stored in the smartphone 30 is insufficient. Furthermore, the notification screen 1302 displays the status message 1310 to inform that the communication between the printing apparatus 10 and the smartphone 30 has been switched from USB communication to wireless LAN communication. Further, the notification screen 1302 displays the instruction message 1312, which is a notification that prompts removing the USB cable 32 to connect the printing apparatus 10 to a terminal device with an enough power supply capacity and also prompts charging the smartphone 30. Furthermore, the notification screen 1302 displays the cancel button 1314, and if the cancel button 1314 is selected, the execution of the input job is canceled.

Returning to FIG. 12, the explanation is continued. Upon providing the notification that prompts ensuring the power supply capacity for the printing apparatus 10 and prompts charging the smartphone 30 in S1212, the processing next proceeds to S1214, where the CPU 402 determines whether or not power is being supplied to the power supply unit 422. In S1214, the status of power supply to the power supply unit 422 is checked, and the processing waits for the start of supplying power to the power supply unit 422 from an external power source or the like. If it is determined in S1214 that power is being supplied to the power supply unit 422, i.e., that charging is being performed, the processing proceeds to S1216, where the CPU 402 transmits a job to the printing apparatus 10. Thereafter, in S1218, the CPU 402 determines whether or not a notification of a job end has been received from the printing apparatus 10. If it is determined in S1218 that a notification of a job end has been received, this job transmission processing ends.

### <Event Processing>

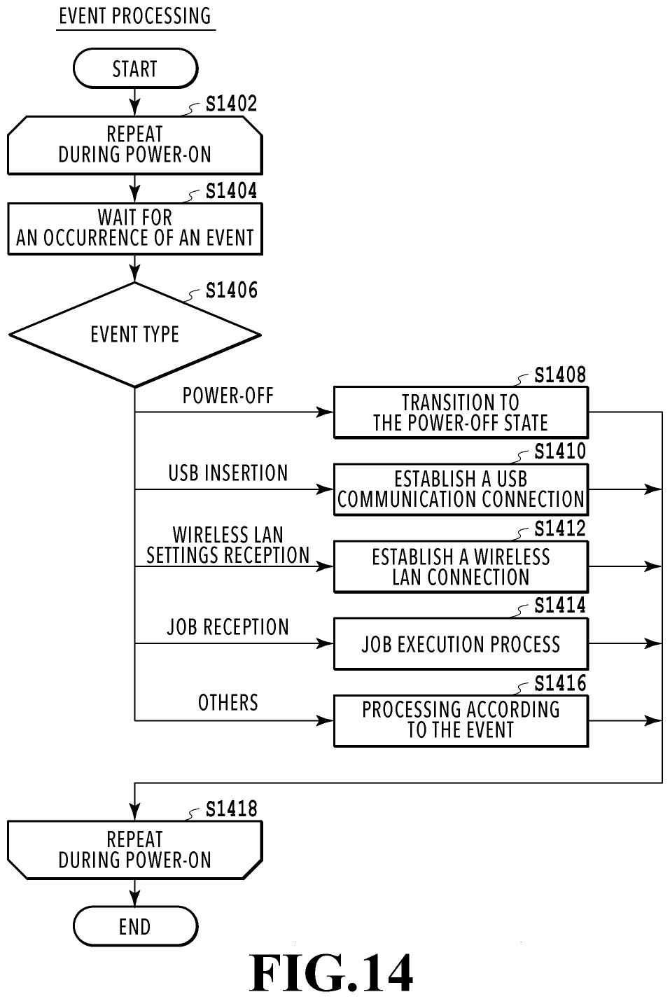

Next, an explanation is given about the event processing executed by the printing apparatus 10. FIG. 14 is a flowchart illustrating the details of processing of the event processing to be executed by the printing apparatus 10 according to the present embodiment. The series of processes illustrated in the flowchart of FIG. 14 is performed by the CPU 216 loading a program code stored in the program memory 218 into the data memory 220 and executing it. Alternatively, part or all of the functions in the steps of FIG. 14 may be executed by hardware such as an ASIC or an electronic circuit.

The event processing starts in a case where the logic power is supplied to the ASIC 314 and an operation of turning on the power supply is performed. Further, in the event processing, the processes from S1402 to S1418 are repeatedly executed in a loop until the printing apparatus 10 is turned off or the logic power supply to the ASIC 314 is cut off. During the loop, in S1404, the CPU 216 waits for the occurrence of an event to be processed. Next, in S1406, the CPU 216 determines the type of the event that has occurred. Each process subsequent to S1406 is what is termed as an event-driven process, in which processing according to the type of the event that has occurred is performed.

Hereinafter, an explanation is given about each process subsequent to S1406. If the event is detection of a power-off operation, the processing proceeds to S1408 to transition to the power-off state. That is, the printing apparatus 10 is brought into the power-off state. As a result, the CPU 216 exits the repeated loop in S1418 and ends the event processing.

If the event is detection of the insertion of a USB cable, the processing proceeds to S1410, where the CPU 216 executes a process of establishing a USB communication connection, which is to be performed after a USB is inserted. In S1410, a connection is established to enable communication between the printing apparatus 10 and the terminal device connected via the USB cable. If the event is reception of wireless LAN setting information from the smartphone 30 via the USB connector 214, the processing proceeds to S1412, where the CPU 216 establishes a wireless LAN connection to enable communication with the smartphone 30 based on the received wireless LAN setting information.

If the event is reception of a job from the smartphone 30 via the USB connector 214 or the wireless LAN unit 210, the processing proceeds to S1414, where the job execution process is performed. Regarding the operation to be performed at the execution of a job, the operation contents are determined by the contents notified by the job, and, in the job execution process, various operations set in the job, such as printing, scanning, copying, or the like, are to be executed. If the event is something else, the processing proceeds to S1416, where the CPU 216 performs processing according to the event that has occurred.

### <Flow of Ensuring the Power Supply Capacity for the Printing Apparatus>

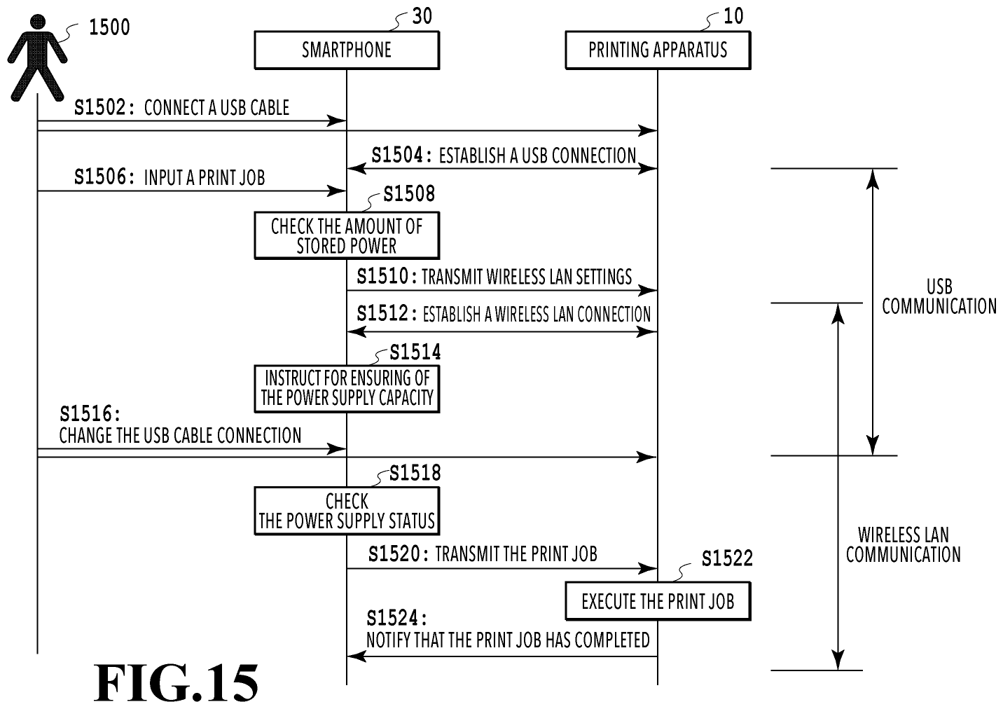

Next, an explanation is given about a flow of charging the smartphone 30 while ensuring the power supply capacity for the printing apparatus 10. FIG. 15 is a sequence diagram illustrating the flow at the time the connection of the USB cable 32 inserted in the printing apparatus 10 according to the second embodiment is switched from the smartphone 30 to the USB power supply adapter 34, which is a terminal device with an enough power supply capacity. Note that, in the explanation using FIG. 15, for ease of understanding, a case of executing a print job is explained.

First, in S1502, the user 1500 connects the printing apparatus 10 and the smartphone 30 via the USB cable 32. As a result, in S1504, a connection (USB connection) is established between the printing apparatus 10 and the smartphone 30 via the USB cable 32, enabling USB communication. Next, in S1506, the user 1500 operates the smartphone 30 to instruct the execution of a print job. In response to this, in S1508, the smartphone 30 checks whether the power supply unit 422 has the amount of stored power capable of executing the printing operation based on the print job (corresponding to S1204). Here, an explanation is given about a case where the power supply unit 422 does not have the amount of stored power capable of executing the printing operation based on the print job.

If it is determined as a result of the checking in S1508 that the power supply unit 422 does not have the amount of stored power capable of executing the printing operation based on the print job, the processing proceeds to S1510, where the smartphone 30 transmits wireless LAN setting information to the printing apparatus 10 (corresponding to S1208). Thereafter, the processing proceeds to S1512, where a wireless LAN connection is established between the printing apparatus 10 and the smartphone 30 based on the wireless LAN setting information. Note that, in this case, it is sufficient that the wireless LAN setting information can be exchanged and supplied between the printing apparatus 10 and the smartphone 30. Therefore, it is also possible that the smartphone 30 requests the printing apparatus 10 for wireless LAN setting information, and the printing apparatus 10 transmits the wireless LAN setting information to the smartphone 30.

If the wireless LAN connection is thus established, next in S1514, the notification screen 1302 is displayed on the touch panel 414 of the smartphone 30 (corresponding to S1212). The user 1500 checks the notification screen 1302 and, in S1516, changes the connection destination of the USB cable 32 to ensure the power supply capacity for the printing apparatus 10. Specifically, the USB cable 32 connecting the printing apparatus 10 and the smartphone 30 is removed from the smartphone 30 and connected to, for example, the USB power supply adapter 34. Further, an external power source is connected to the smartphone 30 to charge the smartphone 30.

In this way, the printing apparatus 10 is capable of USB communication from the time the printing apparatus 10 and the smartphone 30 are connected via the USB cable 32 in S1502 until the time the USB cable 32 is removed from the smartphone 30 in S1516. Further, the printing apparatus 10 is capable of communication in both USB communication and wireless LAN communication modes from the time the wireless LAN connection is established in S1512 until the time the USB cable 32 is removed from the smartphone 30 in S1516. Furthermore, after the USB cable 32 is removed from the smartphone 30 in S1516, the printing apparatus 10 is in a state capable of wireless LAN communication only.

Thereafter, in S1518, the smartphone 30 checks the power supply status (corresponding to S1214), and if power supply has started according to a result of the checking, then in S1520, the smartphone 30 transmits a print job to the printing apparatus 10 (corresponding to S1216). In response to this, in S1522, the printing apparatus 10 executes a printing operation based on the print job, and if the printing operation is completed, then in S1524, the printing apparatus 10 notifies the smartphone 30 of the completion of the print job.

### <Functional Effect>

As explained above, if the amount of power stored in the smartphone 30 is insufficient to execute a job on the printing apparatus 10 connected via a USB cable, the communication mode between the printing apparatus 10 and the smartphone 30 is changed from USB communication to wireless LAN communication. Furthermore, at this time, a notification is provided to prompt switching of the connection of the printing apparatus 10 via the USB cable from the smartphone 30 to a terminal device with an enough power supply capacity and to prompt charging the smartphone 30. As a result, at the time the user switches the USB cable to a terminal device with an enough power supply capacity based on the notification, the communication between the printing apparatus 10 and the smartphone 30 is maintained. Therefore, the user does not need to perform the operation of connecting the printing apparatus 10 and the smartphone 30 after the switching operation, which improves convenience.

### Third Embodiment

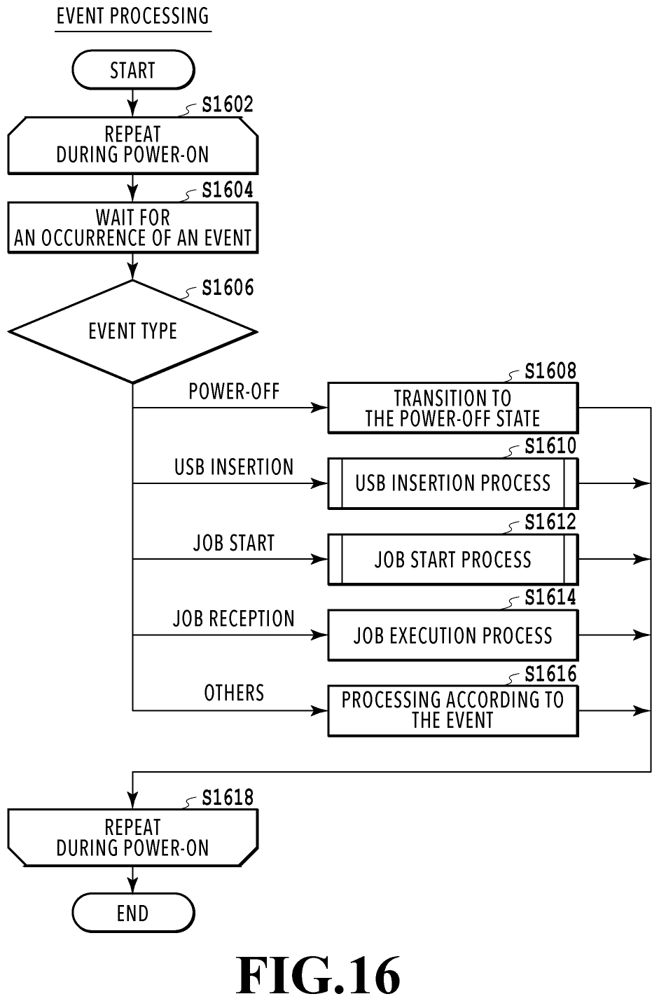

Next, with reference to FIG. 16 to FIG. 20, an explanation is given about a printing apparatus according to the third embodiment. In the following explanation, configurations that are the same or correspond to those of the printing apparatus according to the above-described first embodiment are assigned with the same signs as those used in the first embodiment, thereby omitting detailed explanations thereof.

The third embodiment differs from the above-described first embodiment in an aspect that, after providing a notification that prompts improving the power supply capacity of the printing apparatus 10, USB communication is switched to wireless communication at the timing the source of power supply to the printing apparatus 10 is changed.

### <Event Processing>

In the printing apparatus 10 according to the present embodiment, as with the above-described first embodiment, if the operation of turning on the power supply is performed by providing the logic power supply to the ASIC 314, the event processing for executing processing according to the event type is started.

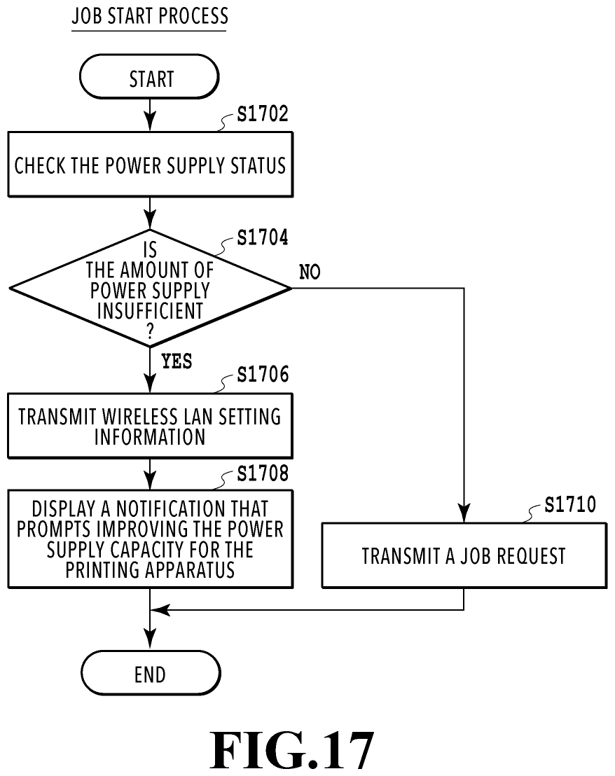

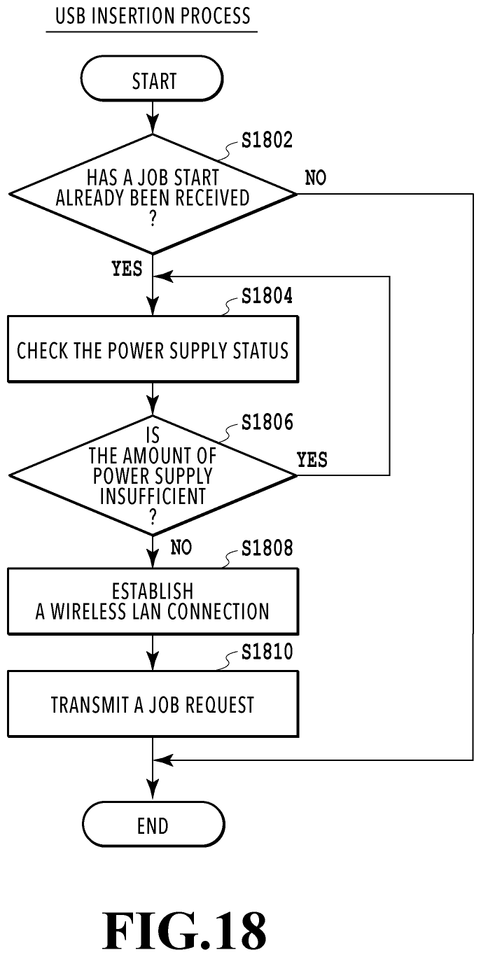

FIG. 16 is a flowchart illustrating the details of processing of the event processing to be executed by the printing apparatus 10 according to the present embodiment. FIG. 17 is a flowchart illustrating the details of processing of the job start process of FIG. 16, which is a subroutine of the event processing. FIG. 18 is a flowchart illustrating the details of processing of the USB insertion process of FIG. 16, which is a subroutine of the event processing. The series of processes illustrated in the flowcharts of FIG. 16 to FIG. 18 is performed by the CPU 216 loading a program code stored in the program memory 218 into the data memory 220 and executing it. Alternatively, part or all of the functions in the steps of FIG. 16 to FIG. 18 may be executed by hardware such as an ASIC or an electronic circuit.

If the event processing is started, the processes from S1602 to S1608 are repeatedly executed in a loop until the printing apparatus 10 is turned off or the logic power supply to the ASIC 314 is cut off. During the loop, in S1604, the CPU 216 waits for the occurrence of an event to be processed, and in S1606, the CPU 216 determines the type of the event that has occurred. Each process subsequent to S1606 is what is termed as an event-driven process, where processing according to the type of the event that has occurred is performed.

Hereinafter, an explanation is given about each process subsequent to S1606. If the event is detection of a power-off operation, the processing transitions to S1608 to transition to the power-off state. As a result, the CPU 216 exits the repeated loop in S1618 and ends the event processing. If the event is detection of the insertion of a USB cable, the processing proceeds to S1610, where the CPU 216 executes the later-descried USB insertion process. If the event is reception of a notification of a job start from the smartphone 30 via the USB connector 214, the processing proceeds to S1612, where the CPU 216 executes the later-described job start process. At this time, for example, a flag for determining whether a notification of a job start has been received is turned ON. If the event is reception of a job from the smartphone 30 via the USB connector 214 or the wireless LAN unit 210, the processing proceeds to S1614, where the job execution process is performed. If the event is something else, the processing proceeds to S1616, where the CPU 216 performs processing according to the event that has occurred.

### =Job Start Process=

Next, an explanation is given about the job start process executed in S1612 with reference to FIG. 17. In the job start process of S1612, first in S1702, the CPU 216 checks the power supply status, then in S1704, the CPU 216 determines whether or not the amount of power supplied from the smartphone 30 is insufficient for the job to be executed. Note that, since the specific details of processing of S1702 and S1704 are the same as those of S802 and S804 described above, the explanations thereof are omitted.

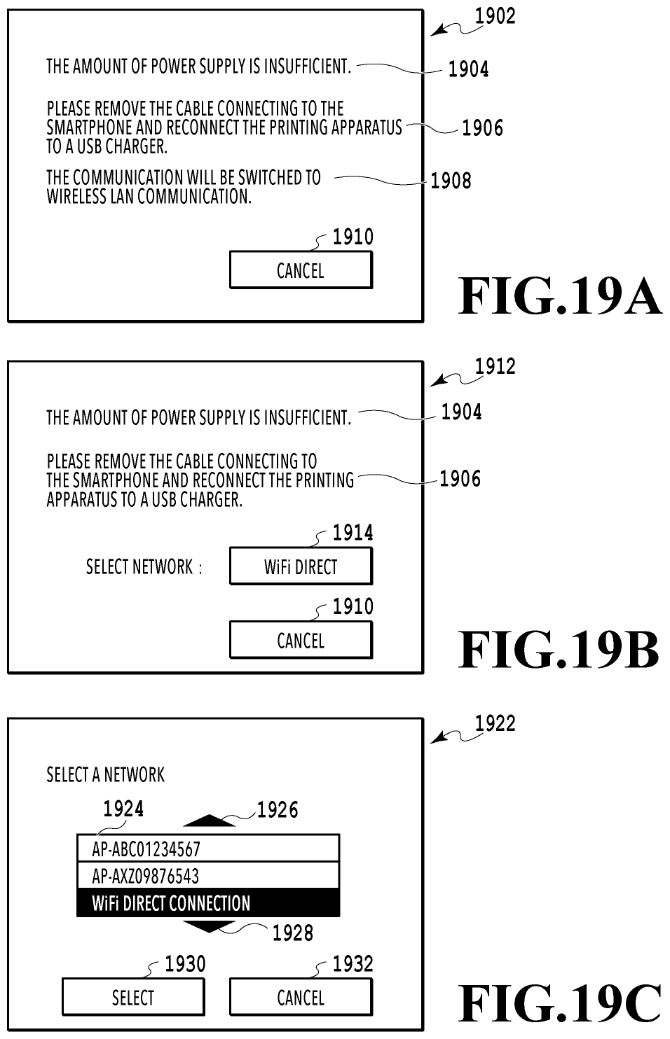

If it is determined in S1704 that the amount of supplied power is insufficient, the processing proceeds to S1706, where the CPU 216 transmits wireless LAN setting information to the smartphone 30. The specific details of processing of S1706 are the same as those of S806 described above. Thereafter, in S1708, the CPU 216 provides a notification that prompts improvement of the power supply capacity for the printing apparatus 10. In S1708, for example, the notification screen 1902 to display a notification that prompts improving the power supply capacity for the printing apparatus 10 is displayed on the display part 240 or touch panel 242 of the operation panel 208 (see FIG. 19A).

Here, an explanation is given about the notification screen to display a notification that prompts improving the power supply capacity for the printing apparatus 10 on the display part 240 or the like. FIGS. 19A and 19C are diagrams illustrating a notification screen to display a notification that prompts improving the power supply capacity for the printing apparatus 10, where FIG. 19A is an example of the notification screen to display the notification, FIG. 19B is a modification example of the notification screen, and FIG. 19C is an example of a network selection screen. The notification screen 1902 displays the error message 1904 to inform that the amount of power supplied to the printing apparatus 10 is insufficient. Further, the notification screen 1902 displays the instruction message 1906, which is a notification that prompts removing the USB cable 32 connecting the printing apparatus 10 and the smartphone 30 to improve the power supply capacity for the printing apparatus 10. In the present embodiment, a notification that prompts a connection to the USB power supply adapter 34 using a Power Delivery 3.0 USB cable (the connection standard and current value that can execute all operations of the printing apparatus 10) is displayed as the notification for improving the power supply capacity for the printing apparatus 10. Furthermore, the status message 1908 is displayed to inform that the communication between the printing apparatus 10 and the smartphone 30 needs to be switched from USB communication via a USB cable to wireless LAN communication. Moreover, the cancel button 1910 is displayed on the notification screen 1902, and if the cancel button 1910 is selected, the execution of the job that has been instructed to start is canceled. Note that the notification screen 1902 may display a continue button in the same manner as the notification screen 1012. Therefore, in this case, if the continue button is selected, the job is executed under a conditional operation without changing the connection destination of the USB cable 32.

The screen displayed on the display part 240 or the like in S1708 is not limited to the notification screen 1902, and the network selection button 1914 may be displayed as in the notification screen 1912 (see FIG. 19B) instead of the status message 1908. The network selection button 1914 is displayed so that a desired network can be selected from a plurality of networks that can be used for wireless connection between the printing apparatus 10 and the smartphone 30. Specifically, if the network selection button 1914 is selected, the network selection screen 1922 that displays selectable networks is displayed (see FIG. 19C).

The network selection screen 1922 displays the list 1924 showing a plurality of selectable networks. In FIG. 19C, three available networks are displayed in a selectable manner, and the third network, which is selected, is highlighted. If there are too many selectable networks to be displayed simultaneously in the list 1924, the displayed contents in the list can be scrolled up and down by selecting the triangular arrow buttons 1926 and 1928 displayed above and below the list 1924.

If the selection button 1930 displayed on the network selection screen 1922 is selected in a state where a network displayed in the list 1924 is selected, the network selected in the list 1924 is confirmed as the network selected by the user. Thereafter, the display screen on the display part 240 or the like returns to the notification screen 1902. Further, if the cancel button 1932 displayed on the network selection screen 1922 is selected, a change of the selected network is not performed, and the display screen on the display part 240 or the like returns to the notification screen 1902. Note that, if a change of the selected network is performed on the network selection screen 1922, the printing apparatus 10 transmits the wireless LAN setting information again to the smartphone 30 so as to establish a connection using the newly selected network.

Returning to FIG. 17, the explanation is continued. On the other hand, if it is determined in S1704 that the amount of supplied power is not insufficient, the processing proceeds to S1710, where the CPU 216 transmits a job request to the smartphone 30 via USB communication, and ends this job start process. Note that, at the time of ending the job start process, the flag that was set to ON upon reception of the notification of a job start is initialized to OFF.

### =USB Insertion Process=

Next, an explanation is given about the USB insertion process executed in S1610 with reference to FIG. 18. In the USB insertion process, first in S1802, the CPU 216 determines whether or not a notification of a job start has already been received. Since the specific details of processing of S1802 is the same as the those of S902 described above, the explanation thereof is omitted. If it is determined in S1802 that a notification of a job start has been unreceived, this USB insertion process ends. Further, if it is determined in S1802 that a notification of a job start has already been received, this USB insertion event is an event that occurs after a process for improving the power supply capacity for the printing apparatus 10 is executed based on the notification screen displayed in the job start process of S1708. Therefore, if it is determined in S1802 that a notification of a job start has already been received, the processing proceeds to S1804, where the CPU 216 checks the power supply status. Since the specific details of processing of S1804 is the same as the those of S904 described above, the explanation thereof is omitted. That is, in S1804, the power supply status in a state where the user has performed a process for improving the power supply capacity for the printing apparatus 10 is to be checked.

Next, in S1806, the CPU 216 determines whether or not the amount of power supply is insufficient for the job to be executed. Since the specific details of processing of S1806 is the same as the those of S906 described above, the explanation thereof is omitted. If it is determined in S1806 that the amount of power supply is insufficient, it is determined that an improvement of the power supply capacity for the printing apparatus 10 has not been appropriately executed, and the processing returns to S1804. Further, if it is determined in S1806 that the amount of power supply is not insufficient, it is determined that the job can be executed, and the processing proceeds to S1808. In S1808, the CPU 216 enables the wireless LAN unit 210 of the printing apparatus 10 while connection is possible using the wireless LAN setting information transmitted in S1706, and waits until a wireless LAN connection with the smartphone 30 is established.

Note that, in the herein-provided explanation, the printing apparatus 10 transmits wireless LAN setting information to the smartphone 30, and the smartphone 30 performs a connection process in accordance with the wireless LAN setting information. However, there is no such limitation. It is also possible that the printing apparatus 10 requests the smartphone 30 for wireless LAN setting information, and uses the wireless LAN setting information received from the smartphone 30 in response, so as to establish a wireless LAN connection from the printing apparatus 10 side. Note that various connection forms can also be used for the wireless LAN connection between the printing apparatus 10 and the smartphone 30. For example, the wireless LAN infrastructure mode connection 38 for establishing a connection via the wireless LAN access point 18 can be used. Alternatively, it is also possible to use a Wi-Fi (registered trademark) direct connection (the direct connection 40) in which the printing apparatus 10 operates as an access point and the smartphone 30 joins it. The connection forms and the connection parameters to be used are to be designated by the wireless LAN setting information.

Once the wireless LAN connection is established, communication between the printing apparatus 10 and the smartphone 30 can be performed using the wireless LAN. As a result, even if the USB cable 32 is removed from the printing apparatus 10, the state where the printing apparatus 10 and the smartphone 30 can communicate with each other is maintained. Therefore, if a wireless LAN connection is established in S1808, the processing proceeds to S1810, where the CPU 216 transmits a job request to the smartphone 30 via wireless LAN communication, and ends this USB insertion process. Note that, after a job request is transmitted, the flag for determining whether a notification of a job start has been received is initialized to OFF.

### <Flow of Improving the Power Supply Capacity for the Printing Apparatus>

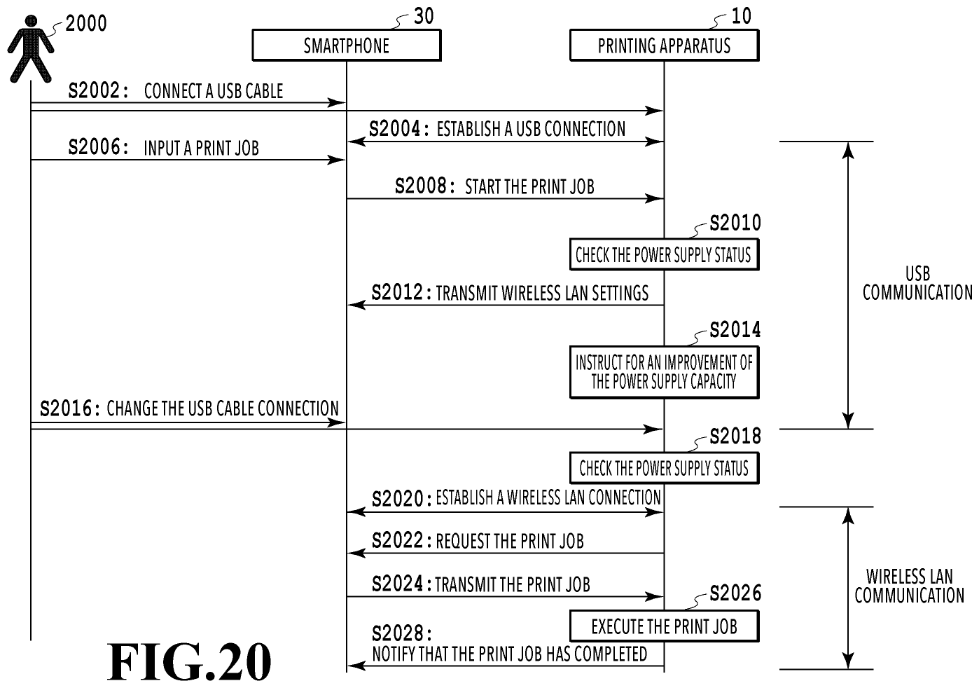

Next, regarding the printing apparatus 10 according to the present embodiment, an explanation is given about a flow of improving the power supply capacity for the printing apparatus 10. FIG. 20 is a sequence diagram illustrating a flow in which power supply for the printing apparatus 10 according to the present embodiment is switched from the smartphone 30 via the USB cable 32 to the USB power supply adapter 34 via a USB cable exhibiting a higher power supply capacity. Note that, in the explanation using FIG. 20, for ease of understanding, a case of executing a print job is explained.

First, in S2002, the user 2000 connects the printing apparatus 10 and the smartphone 30 with the USB cable 32. As a result, in S2004, a connection is established between the printing apparatus 10 and the smartphone 30 via the USB cable 32, enabling USB communication. Next, in S2006, the user 2000 operates the smartphone 30 to input a print job and instruct its execution. In response to this, in S2008, the smartphone 30 transmits a notification of starting a print job to the printing apparatus 10.

Upon receiving the notification of starting a print job, the printing apparatus 10 checks the power supply status in S2010 (corresponding to S1702 and S1704). Here, it is assumed that the result of checking the power supply status indicates that the amount of power supply is insufficient and that the power supply capacity for the printing apparatus 10 needs to be improved. Therefore, in checking the power supply status, it is determined that the amount of power supply is insufficient. If the printing apparatus 10 determines that the amount of power supply is insufficient, then in S2012, the printing apparatus 10 transmits wireless LAN setting information to the smartphone 30 (corresponding to S1706). Note that, in this case, it is sufficient that the wireless LAN setting information can be exchanged and shared between the printing apparatus 10 and the smartphone 30. Therefore, it is also possible to adopt a configuration in which the printing apparatus 10 requests the smartphone for wireless LAN setting information, and the smartphone 30 transmits the wireless LAN setting information to the printing apparatus 10. Therefore, in the present embodiment, the wireless LAN setting information is transmitted and received through USB communication.

Next, in S2014, the printing apparatus 10 displays the notification screen 1902 on the display part 240 of the operation panel 208 (corresponding to S1708). The user 2000 checks the notification screen 1902, and in S2016, executes a process for improving the power supply capacity for the printing apparatus 10. Specifically, the USB cable 32 connecting the printing apparatus 10 and the smartphone 30 is removed from the printing apparatus 10, and the printing apparatus 10 is connected to the USB power supply adapter 34 via, for example, a Power Delivery 3.0 USB cable. As a result, the USB communication that has been possible since the printing apparatus 10 and the smartphone 30 were connected via the USB cable 32 in S2004 is disconnected, and the communication relationship between the printing apparatus 10 and the smartphone 30 is temporarily cut off.

Thereafter, if a connection is established between the printing apparatus 10 and the USB power supply adapter 34, a USB insertion event occurs, and in S2018, the printing apparatus 10 checks the power supply status (corresponding to S1802 and S1804). Here, a description is given of a case where, as a result of executing a process for improving the power supply capacity for the printing apparatus 10, the amount of power supply capable of executing the job is ensured. As a result of checking the power supply status, if it is determined that the amount of power supply is not insufficient (corresponding to S1806), then in S2020, a wireless LAN connection is established between the smartphone 30 and the printing apparatus 10 based on the wireless LAN setting information (corresponding to S1808). Once the wireless LAN connection is established, wireless LAN communication is possible since then, that is, the communication relationship between the printing apparatus 10 and the smartphone 30 is restored.

Once the wireless LAN connection is thus established, then in S2022, the printing apparatus 10 transmits a print job request to the smartphone 30 (corresponding to S1810). In response to this, in S2024, the smartphone 30 transmits a print job to the printing apparatus 10. Then, in S2026, the printing apparatus 10 performs printing based on the print job, and thereafter, in S2028, the printing apparatus 10 transmits a notification to the smartphone 30 that the printing based on the print job has ended.

Note that, in the present embodiment, as described above, the notification screen 1912 may be displayed on the display part 240 in S2014. In this case, if the network is changed through the notification screen 1912, the wireless LAN setting information will be resent based on the change. Note that, if the USB cable 32 is removed in S2016, the printing apparatus 10 is no longer able to transmit the wireless LAN setting information to the smartphone 30. Therefore, at a timing the wireless LAN setting information cannot be transmitted, the network selection button 1914 on the notification screen 1912 is fixed (made un-selectable) or the network selection screen 1922 is disabled.

### <Functional Effect>

As explained above, if the printing apparatus 10 according to the present embodiment determines that a job cannot be executed based on the amount of power supply from the smartphone 30, the communication mode with the smartphone 30 is changed from USB communication to wireless LAN communication. Furthermore, at this time, a notification that prompts improving the power supply capacity for the printing apparatus 10 is provided. Thus, the same functional effects as those of the above-described first embodiment can be obtained.

Further, in the printing apparatus 10 according to the present embodiment, the network to be used can be selected on the notification screen that is displayed before a wireless LAN connection is established. This allows the user to establish a wireless LAN connection using a desired network. Furthermore, since a wireless LAN connection is established after a process for improving the power supply capacity for the printing apparatus 10, even if the USB cable is left removed for a long period of time, a wireless LAN connection is not established, making it possible to reduce unnecessary power consumption.

### Other Embodiments

Note that the above-described embodiments may be modified as shown in the following (1) through (6).
(1) In the above-described embodiments, in order to improve or ensure the power supply capacity for the printing apparatus 10, a change to the USB power supply adapter 34 is performed for the printing apparatus 10 via a USB cable. However, the terminal device connected via a USB cable is not limited to the USB power supply adapter 34, and may be any terminal device as long as sufficient power supply capacity can be ensured. As the terminal device, for example, a PC terminal to which power can be supplied by AC connection can be used. Further, even though the terminal device is battery-powered, as long as the terminal device has a sufficiently large power supply capacity, it can be used as the terminal device to be connected after the change. Examples of a battery-powered terminal device include a mobile battery and a laptop computer. Further, in the above-described embodiments, the smartphone 30 serving as an information processing apparatus is connected to the printing apparatus 10 in a state capable of communication and power supply. However, there is no such limitation. Such an information processing apparatus may be a PC terminal or a known mobile terminal including a tablet terminal.
(2) In the above-described second embodiment, in the job transmission processing, after the notification that prompts ensuring the power supply capacity for the printing apparatus 10 is provided in S1212, the determination is made in S1214 as to whether or not power is being supplied to the power supply unit 422. However, there is no limitation thereto. Even though power is not being supplied to the power supply unit 422, the power consumption of the smartphone 30 can be reduced by removing the USB cable 32 connected to the printing apparatus 10 from the smartphone 30. This is because power consumption is reduced by the amount that power supply from the smartphone 30 to the printing apparatus 10. Therefore, in a case where it is expected that the shortage of power stored in the smartphone 30 can be resolved by simply removing the USB cable 32, the process of S1214 may be omitted.
(3) Although not specifically mentioned in the above-described embodiments, it is assumed that the printing apparatus 10 is capable of printing on a print medium using a known printing method such as an inkjet system. Further, in the above-described embodiments, the printing apparatus 10 is configured to be connected in a wired and wireless manner to an information processing apparatus such as the smartphone 30 via the USB connector 214 and the wireless LAN unit 210. However, there is no such limitation. The printing apparatus 10 may be connected to various information processing apparatuses via various known interfaces or the like in a wired or wireless manner. Note that examples of a known wired interface include a wired LAN interface, etc. In a case of using a wired LAN interface, the LAN cable used is one that complies with a standard that allows power supply as well as communication, such as PoE (Power of Ethernet).
(4) In the above-described first and third embodiments, as a notification for improving the power supply capability for the printing apparatus 10, the notification that prompts connecting to the USB power supply adapter 34 using a Power Delivery 3.0 USB cable is provided. However, there is no such limitation. For example, it is also possible to provide a notification to replace the USB cable 32 with a USB cable exhibiting a power supply capacity (connection standard, current amount) capable of executing the operation based on a job. In this case, for example, USB cables exhibiting a power supply capacity capable of executing the operation based on a job are shown, and a notification that prompts connecting of the printing apparatus 10 and the smartphone 30 via such a USB cable is provided.
(5) Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.
(6) The above-described embodiments and various forms shown in (1) through (5) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212975, filed Dec. 18, 2023, which is hereby incorporated by reference wherein in its entirety.

What is claimed is:

1. A printing apparatus capable of communicating via a wired interface and a wireless interface with a terminal device that can transmit a job for execution of an operation and capable of operating by power supplied by the terminal device connected via the wired interface, the printing apparatus comprising:
a determination unit configured to determine whether or not the operation based on the job can be executed, based on a power supply capacity of the terminal device connected via the wired interface;
a connection control unit configured to connect to the terminal device via the wireless interface for communication in a case where the determination unit determines that the operation based on the job cannot be executed; and
a notification control unit configured to provide a notification that prompts improving the power supply capacity for the printing apparatus in a case where the determination unit determines that the operation based on the job cannot be executed.

2. The printing apparatus according to claim 1,
wherein the notification control unit provides the notification after the connection to the terminal device via the wireless interface is established by the connection control unit.

3. The printing apparatus according to claim 1,
wherein the connection to the terminal device via the wireless interface is established by the connection control unit after the power supply capacity for the printing apparatus is improved.

4. The printing apparatus according to claim 1,
wherein the determination unit makes the determination upon receiving information related to a start of the job from the terminal device.

5. The printing apparatus according to claim 4,
wherein, if the power supply capacity for the printing apparatus is improved after the providing of the notification, the determination unit determines whether or not the operation based on the job can be executed, based on the power supply capacity that has been improved, and
wherein a request for the job is issued to the terminal device in a case where the determination unit determines that the operation based on the job can be executed.

6. The printing apparatus according to claim 2 further comprising
a display unit configured to be capable of displaying information,
wherein the notification is provided via a screen displayed by the display unit.

7. The printing apparatus according to claim 6,
wherein the screen displays a button that allows execution of the operation based on the job without improving the power supply capacity for the printing apparatus, and
wherein, if the button is selected, the operation based on the job is executed under a condition.

8. The printing apparatus according to claim 3 further comprising
a display unit configured to be capable of displaying information,
wherein the notification is provided via a screen displayed by the display unit.

9. The printing apparatus according to claim 8,
wherein a network to be used for the connection to the terminal device via the wireless interface can be selected on the screen.

10. The printing apparatus according to claim 1,
wherein the notification that prompts improving the power supply capacity for the printing apparatus is a notification that prompts connecting the printing apparatus to the terminal device or to another terminal device different from the terminal device via a cable that has a power supply capacity capable of executing the operation based on the job.

11. The printing apparatus according to claim 1,
wherein the notification that prompts improving the power supply capacity for the printing apparatus is a notification that prompts connecting the printing apparatus to a power supply adapter via a cable that has a power supply capacity capable of executing the operation based on the job.

12. The printing apparatus according to claim 1,
wherein the wired interface is a USB interface.

13. The printing apparatus according to claim 1,
wherein the wired interface is a wired LAN interface.

14. The printing apparatus according to claim 1,
wherein the wireless interface is a wireless LAN interface.

15. The printing apparatus according to claim 1,
wherein setting information to be used for connecting to the terminal device via the wireless interface is transmitted and received via the wired interface.

16. A control method for a printing apparatus capable of communicating via a wired interface and a wireless interface with a terminal device that can transmit a job for execution of an operation and capable of operating by power supplied by the terminal device connected via the wired interface, the control method comprising:
a determination step for determining whether or not the operation based on the job can be executed, based on a power supply capacity of the terminal device connected via the wired interface;
a connection control step for connecting to the terminal device via the wireless interface for communication in a case where it is determined in the determination step that the operation based on the job cannot be executed; and
a notification control step for providing a notification that prompts improving the power supply capacity for the printing apparatus in a case where it is determined in the determination step that the operation based on the job cannot be executed.

17. An information processing apparatus capable of communicating with a printing apparatus via a wired interface and a wireless interface, capable of supplying power to the printing apparatus connected via the wired interface, and capable of transmitting a job for execution of an operation to the printing apparatus, the information processing apparatus comprising:
a detection unit configured to be capable of detecting an amount of power stored in a storage unit;
a connection control unit configured to connect to the printing apparatus via the wireless interface for communication in a case where the amount of stored power detected by the detection unit falls below a threshold value; and
a notification control unit configured to provide a notification that prompts ensuring a power supply capacity for the printing apparatus and prompts charging the information processing apparatus in a case where the amount of stored power detected by the detection unit falls below the threshold value.

18. The information processing apparatus according to claim 17,
wherein the detection unit conducts the detection in a case of being connected to the printing apparatus via the wired interface.

19. The information processing apparatus according to claim 18,
wherein the job is transmitted to the printing apparatus if charging is performed after the providing of the notification.

20. The information processing apparatus according to claim 17 further comprising
a display unit configured to display information,
wherein the notification is provided via a screen displayed by the display unit.
